(19) United States
(12) Patent Application Publication
(10) Pub. No.: US 2026/0110937 A1
(43) Pub. Date: Apr. 23, 2026

(54) DISPLAY APPARATUS WITH SWITCHABLE INFINITE MIRROR-IMAGE DISPLAY AREA

(71) Applicant: ALPS ALPINE CO., LTD., Tokyo (JP)

(72) Inventor: Takashi YASUMOTO, Fukushima (JP)

(21) Appl. No.: 19/427,014

(22) Filed: Dec. 19, 2025

Related U.S. Application Data
(63) Continuation of application No. PCT/JP2024/008260, filed on Mar. 5, 2024.

(30) Foreign Application Priority Data
Jul. 12, 2023 (JP) 2023-114745

(51) Int. Cl. G02F 1/1335; G02F 1/1333; G02F 1/1343

(52) U.S. Cl. CPC G02F 1/133553; G02F 1/133331; G02F 1/134309

(57) ABSTRACT

A display apparatus includes: a liquid crystal display; a partially transmissive plate provided on a back surface side of the liquid crystal display; a total reflection mirror provided on a side opposite to the liquid crystal display with respect to the partially transmissive plate and facing the partially transmissive plate with a space from the partially transmissive plate; and a light source having a central axis of light emission directed to the partially transmissive plate or the total reflection mirror and outputting light to a region between the partially transmissive plate and the total reflection mirror.

### CROSS-REFERENCE TO RELATED APPLICATIONS

This application is a continuation application of International Application No. PCT/JP2024/008260, filed on March 5, 2024, and designated the U.S., which is based upon and claims priority to Japanese Patent Application No. 2023-114745, filed on July 12, 2023, the entire contents of which are incorporated herein by reference.

### TECHNICAL FIELD

The present disclosure relates to a display apparatus.

### BACKGROUND ART

Conventionally, there is a display apparatus including a half mirror, a total reflection mirror, and a light source provided between the half mirror and the total reflection mirror. When the display apparatus is viewed from a display surface, an image between the half mirror and the total reflection mirror is overlapped in many layers in a depth direction, and appears to become smaller as it goes deeper (for example, see Japanese Unexamined Utility Model Publication No. 1981-139191).

### SUMMARY OF THE INVENTION

A display apparatus according to an embodiment of the present disclosure includes a liquid crystal display, a partially transmissive plate provided on a back surface side of the liquid crystal display, a total reflection mirror provided on a side opposite to the liquid crystal display with respect to the partially transmissive plate and facing the partially transmissive plate with a space from the partially transmissive plate, and a light source having a central axis of light emission directed to the partially transmissive plate or the total reflection mirror and outputting light to a region between the partially transmissive plate and the total reflection mirror.

### BRIEF DESCRIPTION OF THE DRAWINGS

FIG. 1 is a diagram illustrating an example of a cross-sectional configuration of a display apparatus of a first embodiment;

FIG. 2A is a diagram illustrating a configurational example of glass plates of a liquid crystal display of the display apparatus of the first embodiment;

FIG. 2B is a diagram illustrating a configurational example of the glass plates of the liquid crystal display of the display apparatus of the first embodiment;

FIG. 3 is a graph illustrating an example of a characteristic of a transmittance of visible light of the liquid crystal display with respect to voltage applied to the liquid crystal display of the display apparatus of the first embodiment;

FIG. 4A is a cross-sectional diagram illustrating a configurational example of a display apparatus according to a modified example of the first embodiment;

FIG. 4B is a cross-sectional diagram illustrating a configurational example of the display apparatus according to the modified example of the first embodiment;

FIG. 4C is a cross-sectional diagram illustrating a configurational example of the display apparatus according to the modified example of the first embodiment;

FIG. 4D is a cross-sectional diagram illustrating a configurational example of the display apparatus according to the modified example of the first embodiment;

FIG. 4E is a cross-sectional diagram illustrating a configurational example of the display apparatus according to the modified example of the first embodiment;

FIG. 4F is a cross-sectional diagram illustrating a configurational example of a display apparatus according to the modified example of the first embodiment;

FIG. 4G is a cross-sectional diagram illustrating a configurational example of a display apparatus according to the modified example of the first embodiment;

FIG. 5A is an exemplary diagram illustrating an experimental result of the display of the embodiment;

FIG. 5B is an exemplary diagram illustrating an experimental result of the display of the embodiment;

FIG. 6A is a cross-sectional diagram illustrating a configurational example of the display apparatus according to the modified example of the embodiment;

FIG. 6B is a cross-sectional diagram illustrating a configurational example of the display apparatus according to the modified example of the embodiment;

FIG. 7A is a cross-sectional diagram illustrating a configurational example of a display apparatus according to a second embodiment;

FIG. 7B is a diagram illustrating an example of a positional relationship between two types of light sources of the display apparatus of the second embodiment in a plan view;

FIG. 8A is a cross-sectional diagram illustrating a configurational example of a display apparatus according to a modified example of the second embodiment;

FIG. 8B is a cross-sectional diagram illustrating a configurational example of the display apparatus according to the modified example of the second embodiment;

FIG. 8C is a cross-sectional diagram illustrating a configurational example of the display apparatus according to the modified example of the second embodiment;

FIG. 8D is a cross-sectional diagram illustrating a configurational example of the display apparatus according to the modified example of the second embodiment;

FIG. 8E is a cross-sectional diagram illustrating a configurational example of the display apparatus according to the modified example of the second embodiment;

FIG. 9A is a diagram illustrating an actual measurement example of a gradation control in the display apparatus of the modified example of the second embodiment; and

FIG. 9B is a diagram illustrating an actual measurement example of the gradation control in the display apparatus of the modified example of the second embodiment.

### DETAILED DESCRIPTION OF THE INVENTION

Hereinafter, as described above, an image between the half mirror and the total reflection mirror, that appears to be overlapped in many layers in the depth direction due to multiple reflections and becomes smaller as it goes deeper, is referred to as an infinite mirror image.

Since an infinite mirror image of an existing display apparatus is always displayed, the infinite mirror image cannot be hidden.

Therefore, it is an object of the present invention to provide a display apparatus capable of switching an infinite mirror image to a non-display state.

Hereinafter, embodiments to which a display apparatus according to the present disclosure is applied will be described.

In the following description, an XYZ coordinate system is defined. An X-axis is an example of a first axis, a Y-axis is an example of a second axis, and a Z-axis is an example of a third axis. A direction parallel to the X-axis (X-direction), a direction parallel to the Y-axis (Y-direction), and a direction parallel to the Z-axis (Z-direction) are orthogonal to each other. In the following description, a plan view refers to an XY plane view. In the following description, a +Z-direction is defined as an upward direction and a -Z-direction is defined as a downward direction. However, the above directions do not represent a universal vertical relationship. In the following description, the length, width, thickness, and the like of each part may be exaggerated for easy understanding of the configuration.

### First embodiment

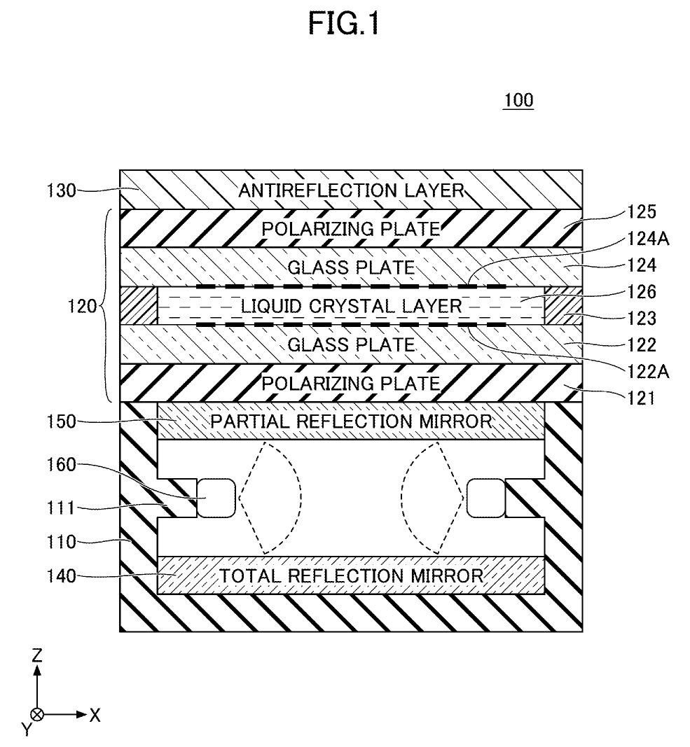

FIG. 1 is a diagram illustrating an example of a cross-sectional configuration of a display apparatus 100 according to a first embodiment. The display apparatus 100 includes a casing 110, a liquid crystal display 120, an antireflection layer 130, a total reflection mirror 140, a partial reflection mirror 150, and light sources 160. The partial reflection mirror 150 is an example of a partially transmissive plate.

The upper surface of the antireflection layer 130 is a display surface of the display apparatus 100. A transparent plate-shaped member such as a cover glass may be provided between the antireflection layer 130 and a polarizing plate 125 of the liquid crystal display 120.

The display apparatus 100 can display an image with a sense of depth because the light output from the light source 160 repeats multiple reflection between the total reflection mirror 140 and the partial reflection mirror 150, and thus reflected virtual images are overlapped in many layers at equal intervals and appear to become smaller as they go deeper.

Hereinafter, an image having a sense of depth due to such multiple reflection is referred to as an infinite mirror image. The infinite mirror image is further readily seen when viewed from a slightly oblique direction than when viewed from the front in the +Z-direction of the display apparatus 100.

### Casing 110

The casing 110 is a housing of the display apparatus 100. The casing 110 is, for example, box-shaped and rectangular in a plan view. The casing 110 includes an opening in an upper portion of the casing 110 and an internal space that communicates with the opening and extends downward. Such an internal space is an example of a region, and more specifically, an example of a three-dimensional region. The total reflection mirror 140 is disposed at the bottom of the internal space of the casing 110, and the partial reflection mirror 150 is provided at the opening of the upper portion. The casing 110 includes a projection 111 projecting toward the center of the internal space in a plan view at each center of the four inner side surfaces in the Z-direction. A plurality of light sources 160 are provided at the tip of the projection 111. Note that the light sources 160 may be provided on the inner wall of the casing 110 or the like without providing the projection 111. The internal space of the casing 110 may be filled and sealed with, for example, a transparent resin. The portion in which the transparent resin is filled and sealed in the internal space in this manner is a three-dimensional region inside the casing 110.

### Liquid crystal display 120

The liquid crystal display 120 is provided on the casing 110. The liquid crystal display 120 includes a polarizing plate 121, a glass plate 122, a sealing seal 123, a glass plate 124, a polarizing plate 125, and a liquid crystal layer 126. The glass plate 124 is an example of a first glass plate, and the glass plate 122 is an example of a second glass plate. The liquid crystal display 120 is, for example, a liquid crystal display driven by a passive driving method.

The polarizing plate 121 is provided on the lower surface of the glass plate 122, and the lower surface of the polarizing plate 121 is in contact with the upper surface of the partial reflection mirror 150. The polarizing plate 121 has a predetermined polarization direction corresponding to the arrangement of the liquid crystals in the liquid crystal layer 126.

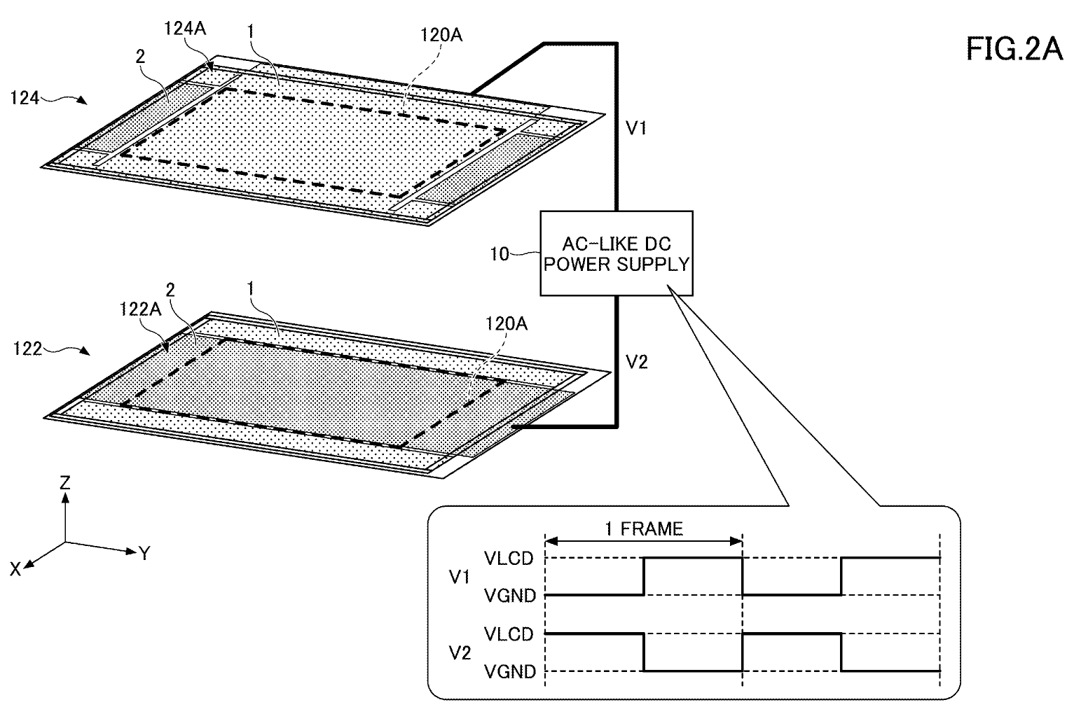

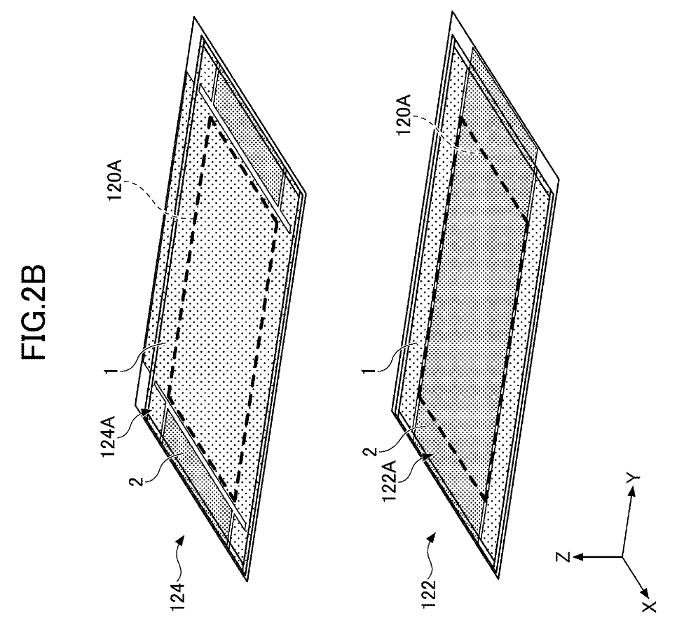

The glass plate 122 is a transparent glass plate provided on a lower surface side of the liquid crystal layer 126. The lower surface side of the liquid crystal layer 126 is an example of a second side (-Z-direction side) opposite to a first side (+Z-direction side) opposite to the partial reflection mirror 150 with respect to the liquid crystal layer 126. The term "transparent" means that light is transmitted. An electrode is provided on the upper surface of the glass plate 122. The position of a switchable area 120A defined by the electrode on the upper surface of the glass plate 122 and an electrode on the lower surface of the glass plate 124 are indicated by broken lines in diagrams. The electrode provided on the upper surface of the glass plate 122 can include a transparent conductive film, and may include an indium tin oxide (ITO) film as an example. The electrode provided on the upper surface of the glass plate 122 will be described in detail in the following with reference to FIGS. 2A and 2B.

The sealing seal 123 is a frame-shaped member provided between the glass plates 122 and 124. In the following, since the display apparatus 100 has a rectangular shape in a plan view as an example, the sealing seal 123 has a rectangular annular shape in a plan view. The sealing seal 123 is made of an insulator, and is made of resin as an example. The sealing seal 123 is bonded between the glass plates 122 and 124, and seals the liquid crystal layer 126 together with the glass plates 122 and 124.

The glass plate 124 is a transparent glass plate provided on the upper side of the liquid crystal layer 126. The upper surface side of the liquid crystal layer 126 is an example of the first side (+Z-direction side) opposite to the partial reflection mirror 150 with respect to the liquid crystal layer 126. The meaning of transparent is the same as that of the glass plate 122. An electrode is provided on the lower surface of the glass plate 124. The position of the switchable area 120A defined by the electrode on the lower surface of the glass plate 124 and the electrode on the upper surface of the glass plate 122 is indicated by the broken lines in drawings. The electrode provided on the lower surface of the glass plate 124 can include a transparent conductive film, and may include the ITO film as an example. The electrode provided on the lower surface of the glass plate 124 will be described in detail in the following with reference to FIGS. 2A and 2B.

The polarizing plate 125 is provided on the glass plate 124. The polarizing plate 125 has a predetermined polarization direction.

The liquid crystal layer 126 is provided in a space sealed by the glass plates 122 and 124 and the sealing seal 123. When voltage is applied to the liquid crystal layer 126 by the electrode on the upper surface of the glass plate 122 and the electrode on the lower surface of the glass plate 124, an alignment direction of liquid crystal molecules changes, and the light transmittance changes when viewed from the upper surface side of the liquid crystal layer 126.

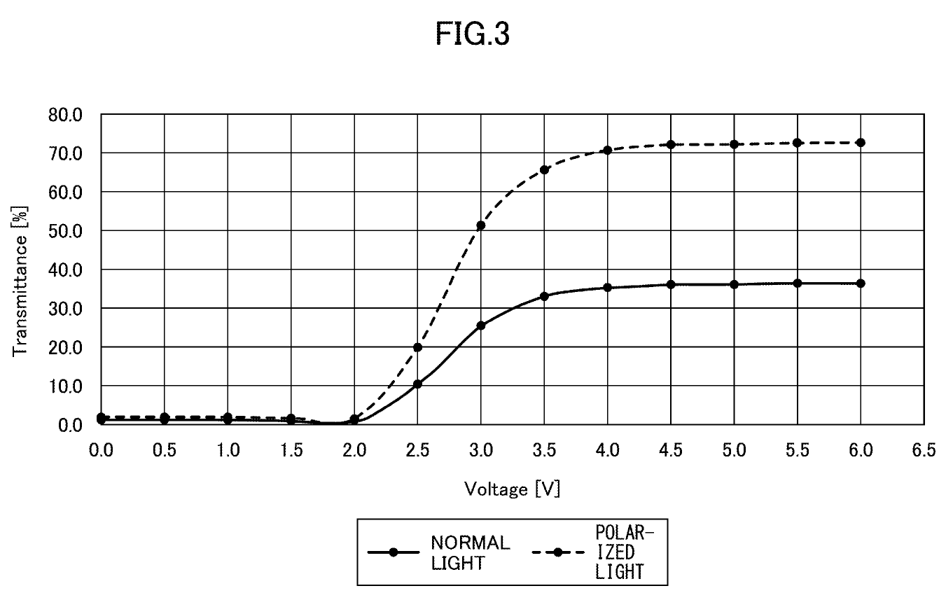

The liquid crystal layer 126 is configured to become transparent and transmit light when an electric field is applied to the liquid crystal layer 126, and to become opaque and not transmit light when no electric field is applied to the liquid crystal layer 126. The control of the transmittance of the liquid crystal layer 126 will be described in the following with reference to FIG. 3.

### Antireflection layer 130

The antireflection layer 130 is provided on the uppermost surface of the display apparatus 100. The antireflection layer 130 includes an anti-reflection (AR) film, for example. The antireflection layer 130 may be provided on a surface of a transparent plate-shaped member such as a cover glass. Note that such a transparent plate-shaped member such as the cover glass is an example of a protective plate.

### Total reflection mirror 140

The total reflection mirror 140 is provided at the bottom of the internal space of the casing 110, and the upper surface of the total reflection mirror 140 is a reflection surface that totally reflects light. The total reflection mirror 140 can be manufactured by, for example, polishing the upper surface of a plate-like member and depositing aluminum on the upper surface. The total reflection mirror 140 is not limited to such a configuration, and may be a mirror having any configuration as long as the mirror includes a reflection surface that totally reflects light as an upper surface.

### Partial reflection mirror 150

The partial reflection mirror 150 is provided in an opening in the upper portion of the casing 110. The light transmittance of the partial reflection mirror 150 may be set to an appropriate value within a range from about 20% to about 80%, and more preferably, may be set to an appropriate value within a range from about 30% to about 70%, as an example. Here, as an example, the light transmittance of the partial reflection mirror 150 is assumed to be 50%.

The partial reflection mirror 150 transmits a part of the light transmitted through the liquid crystal display 120 from the upper side to the lower side from the upper surface to the lower surface of the partial reflection mirror 150, and reflects the remaining light on the upper surface of the partial reflection mirror 150 toward the liquid crystal display 120. The partial reflection mirror 150 transmits light coming from below from the lower surface toward the upper surface of the partial reflection mirror 150, and reflects the remaining light downward on the lower surface of the partial reflection mirror 150.

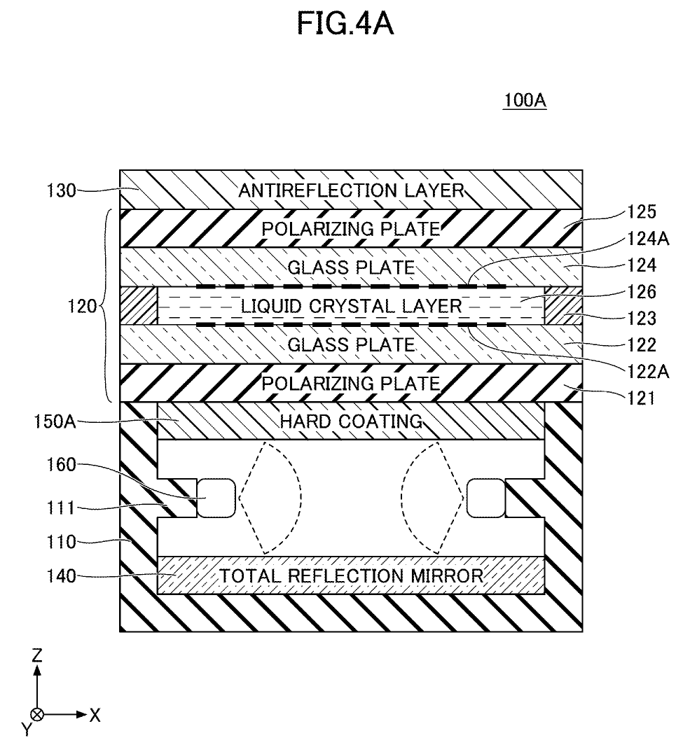

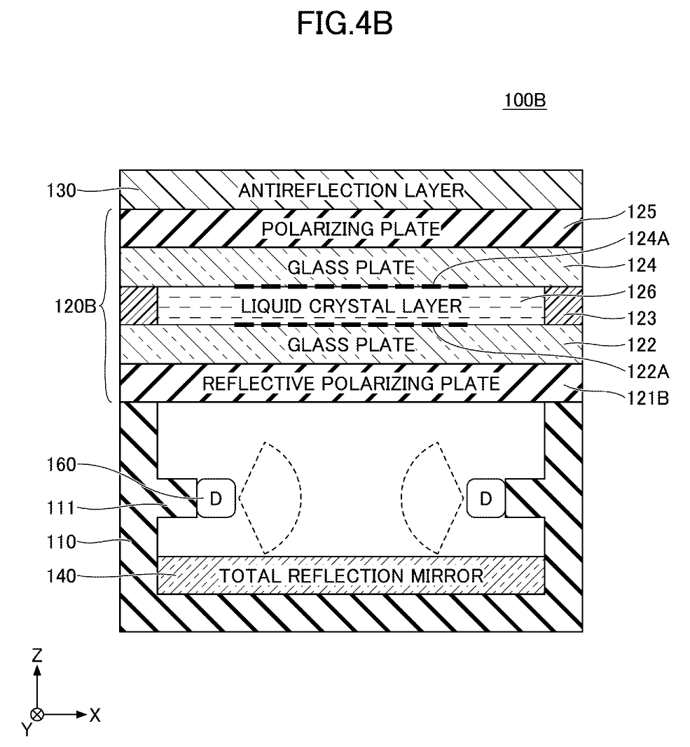

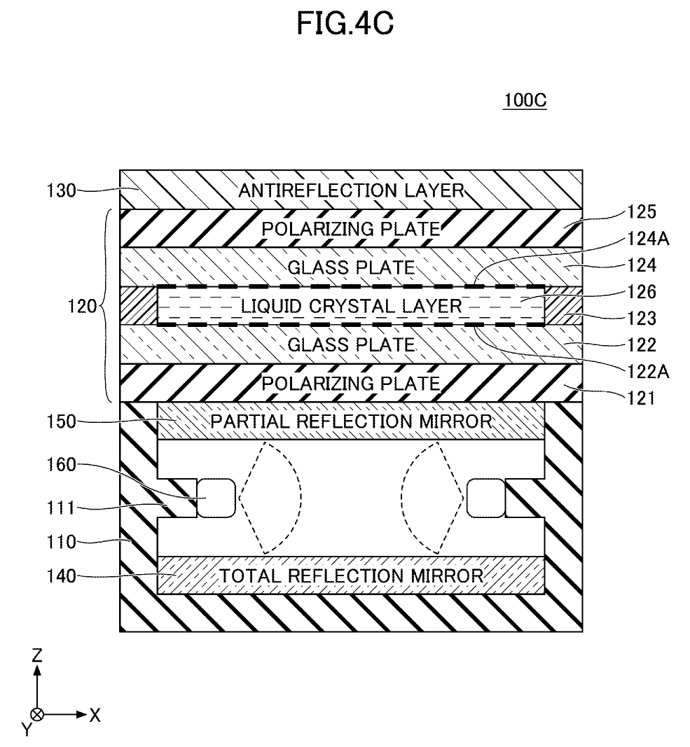

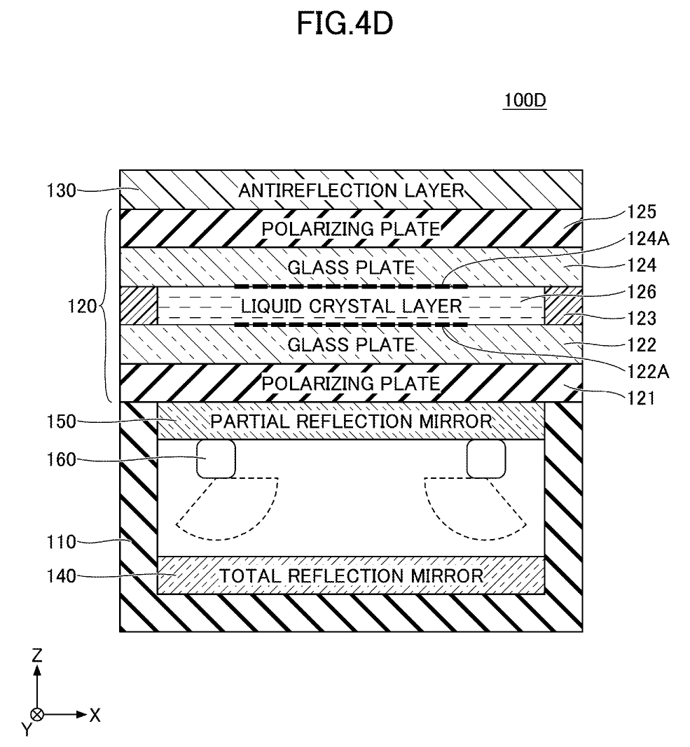

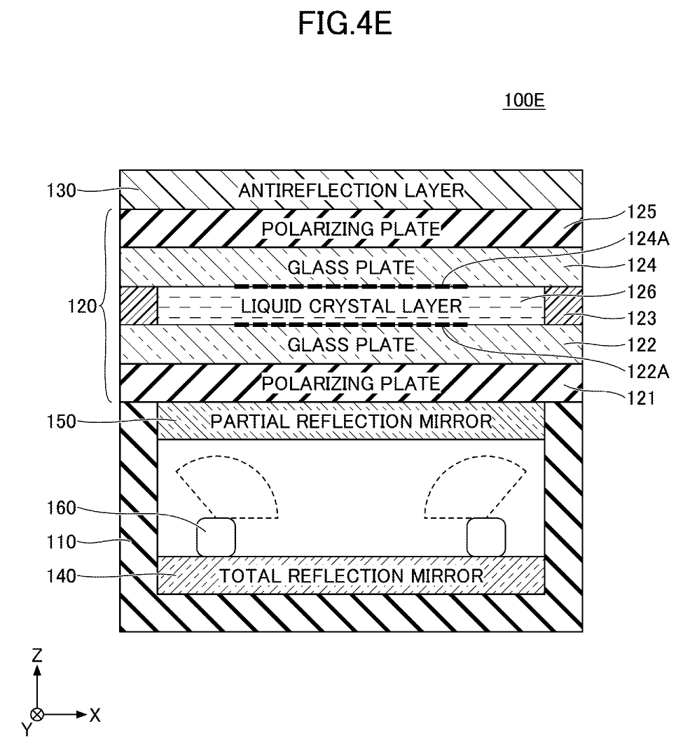

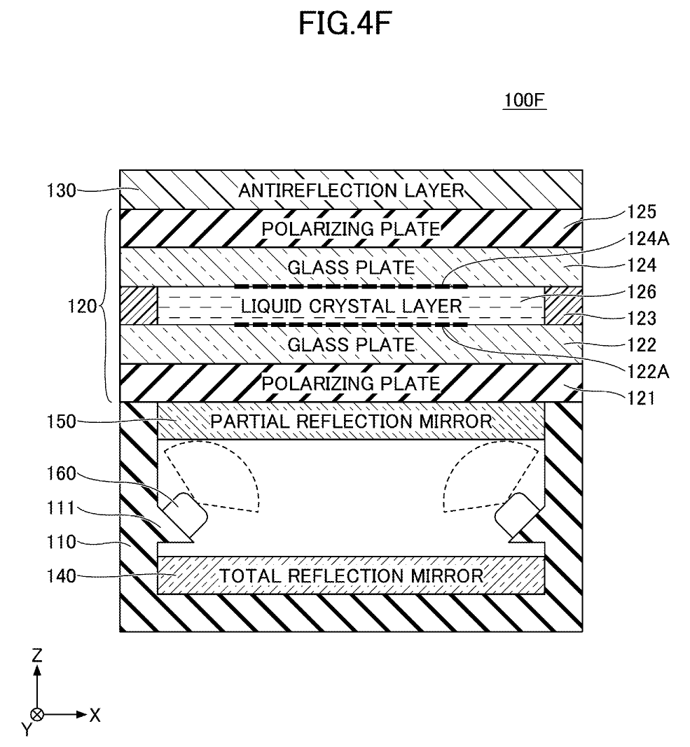

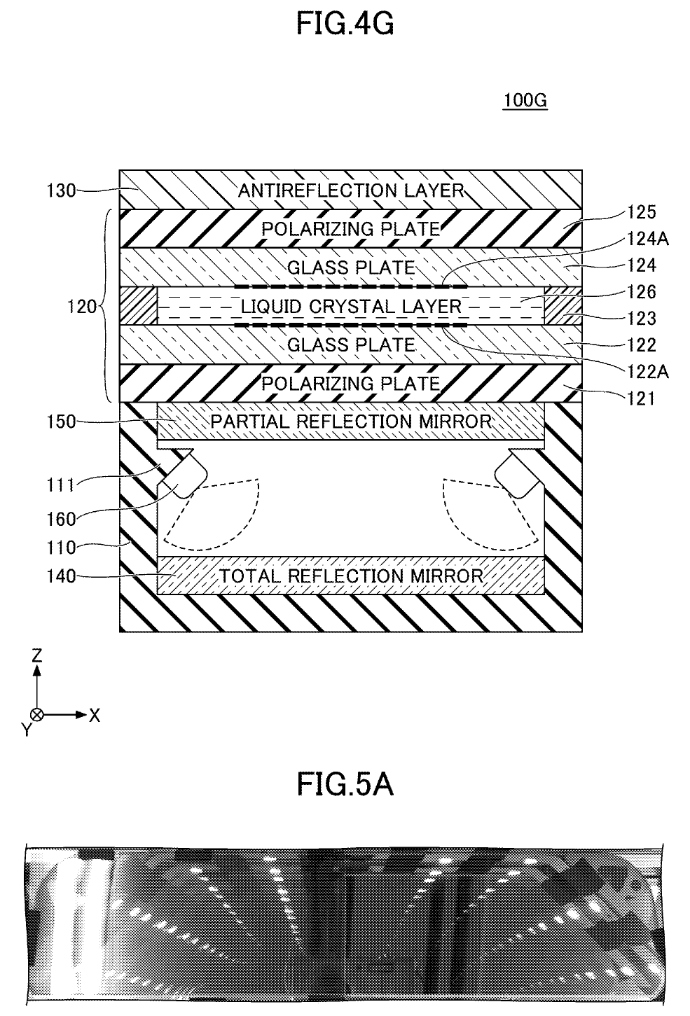

Here, an embodiment in which the partial reflection mirror 150 is used as an example of the partially transmissive plate will be described. However, the partially transmissive plate may be a plate-shaped member that transmits a part of incident light. Furthermore, since the light that is not transmitted through the partially transmissive plate is reflected on the surface of the partially transmissive plate of such a plate-like member, the partially transmissive plate transmits a part of the incident light and reflects the remaining light. The reflectivity of the partially transmissive plate may be very low, such as 10% or less, as an example. The partially transmissive plate other than the partial reflection mirror 150 will be described in the following with reference to FIG. 4A.

### Light source 160

The plurality of light sources 160 are provided at the tip of the projection 111 of the casing 110. The light source 160 is, for example, a light emitting diode (LED), but may be a light emitter other than the LED. As an example, the projection 111 extends from each of the four inner side surfaces of the casing 110 toward the center of the internal space of the casing 110 in a plan view, and the light sources 160 are arranged in a rectangular annular shape at equal intervals in a plan view. The plurality of light sources 160 are disposed outside the switchable area of the liquid crystal display 120 in a plan view. The light source 160 outputs light to a space (region) between the partial reflection mirror 150 and the total reflection mirror 140.

A terminal of each light source 160 is connected to an external device of the display apparatus 100 via a wiring or the like (not illustrated), and lighting control of each light source 160 is performed by the external device, for example.

The central axes of light emission of the light sources 160 are inclined with respect to a straight line (a straight line parallel to the Z-axis) perpendicular to the lower surface of the partial reflection mirror 150 and the upper surface of the total reflection mirror 140. Each central axis of light emission of the light source 160 is a central axis of a three-dimensional irradiation range of light output by the light source 160. This is because, by inclining the central axis of the light emission of the light source 160 with respect to the straight line perpendicular to the lower surface of the partial reflection mirror 150 and the upper surface of the total reflection mirror 140 (the straight line parallel to the Z-axis), the light is obliquely incident on the total reflection mirror 140 and the partial reflection mirror 150, the number of times of multiple reflection increases, and an infinite mirror image with a greater depth is obtained.

The central axis of the light emission of the light source 160 has an angle of about 70 degrees in absolute value with respect to the straight line (the straight line parallel to the Z-axis) perpendicular to the lower surface of the partial reflection mirror 150 and the upper surface of the total reflection mirror 140, as an example. In other words, the central axis of the light emission of the light source 160 has an angle of about 20 degrees upward or downward with respect to a horizontal direction, as an example.

### Configuration of glass plates 122 and 124

FIGS. 2A and 2B are diagrams illustrating the configuration of the glass plates 122 and 124 of the liquid crystal display 120. In FIGS. 2A and 2B, an electrode 122A of the glass plate 122 and an electrode 124A of the glass plate 124 are transparently illustrated. The electrode 122A is provided on substantially the entire upper surface (the surface on the +Z-direction side) of the glass plate 122, and the electrode 124A is provided on substantially the entire lower surface (the surface on the -Z-direction side) of the glass plate 124. Each of the electrodes 122A and 124A can be formed of a transparent conductive film, and is formed of the ITO film as an example.

Furthermore, FIG. 2A illustrates a state in which a control voltage is applied to the electrodes 122A and 124A of the liquid crystal display 120, and FIG. 2B illustrates a state in which a control voltage is not applied to the electrodes 122A and 124A of the liquid crystal display 120. For this reason, an alternating-current (AC)-like direct-current (DC) power supply 10 is illustrated in FIG. 2A.

The electrodes 122A and 124A are arranged so as to face each other. The electrode 122A includes two electrodes 1 and one electrode 2. The electrode 124A includes one electrode 1 and two electrodes 2. The electrodes 1 of the electrode 122A and the electrode 1 of the electrode 124A are an example of a pair of first electrodes. The electrode 2 of the electrode 122A and the electrodes 2 of the electrode 124A are an example of a pair of second electrodes.

The two electrodes 1 of the electrode 122A and the one electrode 1 of the electrode 124A are connected to each other via a wiring or the like (not illustrated), and are configured to have the same potential. One electrode 2 of the electrode 122A and two electrodes 2 of the electrode 124A are connected to each other via a wiring or the like (not illustrated) and are configured to have the same potential. Furthermore, as an example, the AC-like DC voltages V1 and V2 having opposite phases and equal amplitudes are applied from the AC-like DC power supply 10 to the electrode 1 of the electrode 124A and the electrode 2 of the electrode 122A, respectively. As illustrated in the lower part of FIG. 2A, the AC-like DC voltages V1 and V2 have a period in which VLCD (> VGND) is applied and a period in which VGND is applied in one frame. The VGND is a ground voltage.

Therefore, in a state where the AC-like DC power supply 10 outputs the AC-like DC voltage, a potential difference is generated between the electrodes 1 and 2. In addition, in a state where the AC-like DC power supply 10 outputs the AC-like DC voltage, the two electrodes 1 of the electrode 122A and the one electrode 1 of the electrode 124A have the same potential, and the one electrode 2 of the electrode 122A and the two electrodes 2 of the electrode 124A have the same potential.

The switchable area 120A of the liquid crystal display 120 according to the configuration of the electrodes 122A and 124A is illustrated in FIGS. 2A and 2B.

The switchable area 120A is a region in which the image to be displayed can be switched, on the display surface of the liquid crystal display 120. The switchable area 120A is located in a central portion excluding a rectangular annular portion along an outer edge of the display surface of the liquid crystal display 120 in a plan view. The width of the rectangular annular-shaped portion along the outer edge of the display surface (the width between the outer edge of the display surface and the switchable area 120A) is, for example, approximately 1 mm to 20 mm. The width of the rectangular annular-shaped portion along the outer edge of the display surface may be narrower than 1 mm or wider than 20 mm.

In the switchable area 120A, the electrode 2 of the electrode 122A and the electrode 1 of the electrode 124A are provided.

### ELECTRODE 122A

The electrode 122A is configured such that the electrode 1, electrode 2, and electrode 1 are arranged in this order from the -X-direction side to the +X-direction side.

The electrode 1 on the -X-direction side of the electrode 122A is provided on the -X-direction side of the switchable area 120A in the X-direction, and extends from the end of the electrode 122A on a -Y-direction side to the end of the electrode 122A on a +Y-direction side in the Y-direction. The electrode 1 on the +X-direction side of the electrode 122A is provided on the +X-direction side of the switchable area 120A in the X-direction, and extends from the end on the -Y-direction side to the end of the +Y-direction side of the electrode 122A.

The electrode 2 of the electrode 122A extends in the X-direction within a section between the end of the switchable area 120A on a -X-direction side and the end of the switchable area 120A on the +X-direction side, and extends in the Y-direction from the end of the electrode 122A on the -Y-direction side to the end of the electrode 122A on the +Y-direction side. The electrode 2 of the electrodes 122A that applies voltage to the switchable area 120A extends to the end of the glass plate 122 in the Y-direction (second direction) that crosses the X-direction (first direction) in a plan view.

The electrode 2 of the electrode 122A is connected to the AC-like DC power supply 10 via a terminal or the like connected to the end of the glass plate 122 on the +Y-direction side, for example. This is because when the electrode 2 of the electrode 122A extends to the end of the glass plate 122, the electrode 2 of the electrode 122A of the electrodes can be readily connected to the AC-like DC power supply 10 outside the liquid crystal display 120. The electrode 2 of the electrode 122A that applies voltage to the switchable area 120A may be connected to the AC-like DC power supply 10 by connecting a terminal or the like to the end of the glass plate 122 on the -Y-direction side, for example.

The two electrodes 1 of the electrode 122A are connected to the electrode 1 of the electrode 124A by sandwiching a conductor between the electrode 1 of the electrode 124A and the two electrodes 1 of the electrode 122A, for example. The two electrodes 1 of the electrode 122A may be connected to the electrode 1 of the electrode 124A via wiring or the like connected to the electrode 1 of the electrode 124A, for example. The two electrodes 1 of the electrode 122A may be connected to the AC-like DC power supply 10 via terminals or the like connected to the ends in the -X-direction and + X-direction, for example. In this way, the two electrodes 1 of the electrode 122A and the electrode 1 of the electrode 124A are held at the same potential.

### Electrode 124A

The electrode 124A includes an H-shaped electrode 1 and two rectangular electrodes 2. The two rectangular electrodes 2 are respectively arranged in two remaining portions obtained by excluding the H-shaped electrode 1 portion from the electrode 124A having a rectangular shape as a whole in a plan view.

The electrode 2 on the -Y-direction side of the electrode 124A extends within a section between the end on the -X-direction side and the end on the +X-direction side of the switchable area 120A in the X-direction, and is located on the -Y-direction side of the switchable area 120A in the Y-direction. The electrode 2 on the +Y-direction side of the electrode 124A extends within a section between the end on the -X-direction side and the end on the +X-direction side of the switchable area 120A in the X-direction, and is located on the +Y-direction side of the switchable area 120A in the Y-direction.

The electrode 1 of the electrode 124A is provided in the remaining H-shaped portion obtained by excluding the two electrodes 2 described above from the electrode 124A portion having a rectangular shape as a whole in a plan view. The electrode 1 of the electrode 124A that applies voltage to the switchable area 120A extends to the ends of the glass plate 124 in the X-direction (first direction). The electrode 1 of the electrode 124A is connected to the AC-like DC power supply 10 via a terminal or the like connected to the end of the glass plate 124 on the -X-direction side, for example.

This is because when the electrode 1 of the electrode 124A extends to the ends of the glass plate 124, the electrode 1 of the electrode 124A can be readily connected to the AC-like DC power supply 10 outside the liquid crystal display 120. The electrode 1 of the electrode 124A that applies voltage to the switchable area 120A may be connected to the AC-like DC power supply 10 by connecting a terminal or the like to the end of the glass plate 124 on the +X-direction side, for example.

The two electrodes 2 of the electrode 124A are connected to the electrode 2 of the electrode 122A by sandwiching a conductor between the electrode 2 of the glass plate 122 and the electrodes 2 of the electrode 124A, for example. The two electrodes 2 of the electrode 124A may be connected to the electrode 2 of the electrode 122A via, for example, wires connected to the electrode 2 of the electrode 122A. The two electrodes 2 of the electrode 124A may be connected to the AC-like DC power supply 10 via terminals or the like connected to the ends in the -Y-direction and the +Y-direction, for example. In this way, the two electrodes 2 of the electrode 124A and the electrode 2 of the electrode 122A are held at the same potential.

In the electrodes 122A and 124A, the electrode 2 of the electrode 122A and the electrodes 2 of the electrode 124A face each other in a portion in a section between the end of the switchable area 120A on the -Y-direction side and the end of the switchable area 120A on the +Y-direction side in the Y-direction, in the portion outside the switchable area 120A. The electrodes facing each other is synonymous with the electrodes overlapping with each other with a space therebetween.

As illustrated in FIG. 2A, when an AC-like DC voltage is applied between the electrodes 1 and 2 from the AC-like DC power supply 10, a potential difference is generated between the electrodes 1 and 2, and an electric field is generated in the switchable area 120A of the liquid crystal layer 126. Even when an AC-like DC voltage is applied between the electrodes 1 and 2 from the AC-like DC power supply 10 to generate a potential difference between the electrodes 1 and 2, no potential difference is generated in the portion of the liquid crystal layer 126 outside the switchable area 120A, and therefore no electric field is generated.

The liquid crystal layer 126 is in a state of being capable of transmitting light when an electric field is applied thereto, and is in a state of not transmitting light when no electric field is applied thereto. Therefore, when an AC-like DC voltage is applied between the electrodes 1 and 2, the switchable area 120A is in a state capable of transmitting light. In the portion of the liquid crystal display 120 outside the switchable area 120A, the electrodes 1 face each other and the electrodes 2 face each other, and therefore, even when an AC-like DC voltage is applied between the electrodes 1 and 2, the liquid crystal layer 126 is held in a state in which light is not transmitted.

In addition, in a state where the AC-like DC voltage is not applied between the electrodes 1 and 2, a potential difference is not generated between the electrodes 1 and 2 in the switchable area 120A, and thus the switchable area 120A is in a state where light is not transmitted. In addition, in the portion of the liquid crystal display 120 outside the switchable area 120A, the electrodes 1 facing each other and the electrodes 2 facing each other are at the same potential, and thus the liquid crystal layer 126 is held in a state in which light is not transmitted.

In this manner, by switching between the state in which the AC-like DC voltage is applied between the electrodes 1 and 2 and the state in which the AC-like DC voltage is not applied between the electrodes 1 and 2, a transmissive state of the switchable area 120A of the liquid crystal display 120 can be switched like a shutter of an imaging device. In the portion of the liquid crystal display 120 outside the switchable area 120A, the liquid crystal layer 126 is always kept in a state of not transmitting light regardless of whether or not the AC-like DC voltage is applied between the electrodes 1 and 2.

Since the display apparatus 100 can display an infinite mirror image, the display apparatus 100 can switch between a state in which an infinite mirror image is displayed and a state in which an infinite mirror image is not displayed by switching the transmissive state of the switchable area 120A of the liquid crystal display 120.

Since the space between the glass plates 122 and 124 is sealed by the sealing seal 123 along the outer edges (four sides) of the glass plates 122 and 124, the electrodes 122A and 124A may be offset inward from the outer edges (four sides) of the glass plates 122 and 124 in a plan view so as not to overlap with the sealing seal 123. However, since the electrodes 122A and 124A are connected to the AC-like DC power supply 10 via terminals or the like, it is sufficient that the portions of the electrodes 122A and 124A that are connected to the terminals or the like extend to the outer edges of the glass plates 122 and 124. In this case, the portions of the glass plates 122 and 124 where the electrodes 122A and 124A connected to the terminals and the like are formed may project outward from the sealing seal 123 in a plan view.

### Light transmittance in liquid crystal display 120

FIG. 3 is a diagram illustrating an example of the light transmittance characteristics of the liquid crystal display 120 with respect to the voltage applied to the liquid crystal display 120. The voltage applied to the liquid crystal display 120 is an AC-like DC voltage of an opposite phase applied between the electrodes 1 and 2. The voltage indicated by the horizontal axis in FIG. 3 represents the amplitude of the AC-like DC voltage of the opposite phase.

In FIG. 3, a solid line indicates light transmittance characteristics when a polarization cover is not attached to the light sources 160 (without the polarization cover), and a broken line indicates the light transmittance characteristics when the polarization cover is attached to the light sources 160 (with the polarization cover). A polarization direction of the polarizing cover attached to the light sources 160 coincides with the polarization direction of the polarizing plate 121 below the liquid crystal layer 126.

From a voltage of 0.0 V to a voltage of about 2.0 V, the transmittances of both the light sources 160 with the polarizing cover and the light sources 160 without the polarizing cover were very low values of about 1% to about 2%. This state is a state in which light is not transmitted. Also, when the voltage exceeded 2.0 V, the transmission began to increase rapidly for both the light sources 160 with the polarizing cover and the light sources 160 without the polarizing cover. The rate of increase in the transmittance of the light sources 160 with the polarizing cover was greater than the rate of increase in the transmittance of the light sources 160 without the polarizing cover.

When the voltage exceeded about 4.0 V, the transmittances of both the light sources 160 with the polarizing cover and the light sources 160 without the polarizing cover became substantially constant. When the voltage was increased to 6.0 V, the maximum value of the transmission of the light sources 160 with the polarizing cover was about 73%, and the maximum value of the transmission of the light sources 160 without the polarizing cover was about 37%. The maximum value of the transmittance of the light sources 160 with the polarizing cover was about twice the maximum value of the transmittance of the light sources 160 without the polarizing cover.

As described above, it was confirmed that the transmittance of the liquid crystal display 120 can be switched between a very low value of about 1% to about 2% and a value capable of transmitting light such as about 37% or about 73% by controlling the voltage applied to the electrodes 1 and 2.

For example, in order to immediately switch the switchable area 120A from a non-transmissive state to the transmissive state, the voltage applied to the electrodes 1 and 2 may be immediately increased from 0.0 V to 6.0 V. Also, for example, to gradually switch the switchable area 120A from the non-transmissive state to the transmissive state, the voltage applied to the electrodes 1 and 2 may be gradually increased from 2.0 V to 4.0 V.

### Display apparatuses 100A to 100G of modified example of first embodiment

FIG. 4A to FIG. 4G are cross-sectional diagrams illustrating examples of the configuration of display apparatuses 100A to 100G according to modified examples of the first embodiment. FIGS. 4A to 4G illustrate cross-sectional configurations in an XZ plane corresponding to the display apparatus 100 illustrated in FIG. 1. The same components as those of the display apparatus 100 as illustrated in FIG. 1 are denoted by the same reference numerals, and the description thereof will be omitted.

### Display apparatus 100A

A display apparatus 100A as illustrated in FIG. 4A includes a hard coating 150A in place of the partial reflection mirror 150 of the display apparatus 100 as illustrated in FIG. 1. The hard coating 150A is an example of the partially transmissive plate.

The hard coating 150A is, as an example, a semi-transparent hard resin layer. The reflectance of the hard coating 150A is lower than the transmittance of the hard coating 150A. The reflectance of the hard coating 150A may be, for example, about 10% or lower than 10%. That is, the transmittance of the hard coating 150A may be about 90% or higher than 90%.

The hard coating 150A transmits a part of light transmitted through the liquid crystal display 120 from the upper side to the lower side, from the upper surface to the lower surface of the hard coating 150A, and reflects the remaining light on the upper surface toward the liquid crystal display 120. The hard coating 150A transmits light coming from below from the lower surface toward the upper surface of the hard coating 150A, and reflects the remaining light downward on the lower surface of the hard coating 150A.

Therefore, the display apparatus 100A including the hard coating 150A displays the infinite mirror image itself thinly by the amount of the lower reflectivity than the partial reflection mirror 150, but the infinite mirror image itself can be displayed similarly to the display apparatus 100 including the partial reflection mirror 150. Therefore, even when the hard coating 150A is used instead of the partial reflection mirror 150, it is possible to provide the display apparatus 100A capable of switching the infinite mirror image to the non-display state. Furthermore, since the hard coating 150A is less expensive than the partial reflection mirror 150, the display apparatus 100A with reduced manufacturing cost can be provided. Note that the light sources 160 may be provided on the inner wall of the casing 110 or the like without providing the projection 111.

### Display apparatus 100B

A display apparatus 100B as illustrated in FIG. 4B includes a reflective polarizing plate 121B in place of the polarizing plate 121 and the partial reflection mirror 150 of the display apparatus 100 as illustrated in FIG. 1. The reflective polarizing plate 121B is included in a liquid crystal display 120B. The liquid crystal display 120B includes the reflective polarizing plate 121B instead of the polarizing plate 121 as illustrated in FIG. 1.

The reflective polarizing plate 121B functions as a polarizing plate similarly to the polarizing plate 121, and also has a function similar to that of the partial reflection mirror 150. The reflective polarizing plate 121B is an example of the partially transmissive plate. The light transmittance of the reflective polarizing plate 121B may be set to an appropriate value within a range from about 20% to about 80%, and more preferably, may be set to an appropriate value within a range from about 30% to about 70%, as an example. In the following, as an example, the light transmittance of the reflective polarizing plate 121B is assumed to be 50%.

The reflective polarizing plate 121B polarizes a part of light transmitted through the liquid crystal display 120 from the upper side to the lower side, transmits the light from the upper surface to the lower surface of the reflective polarizing plate 121B, and reflects the remaining light on the upper surface of the reflective polarizing plate 121B toward the liquid crystal display 120. The reflective polarizing plate 121B transmits and polarizes light coming from below from the lower surface toward the upper surface of the reflective polarizing plate 121B, and reflects the remaining light downward on the lower surface of the reflective polarizing plate 121B.

Therefore, the display apparatus 100B including the reflective polarizing plate 121B can operate in the same manner as the display apparatus 100 including the polarizing plate 121 and the partial reflection mirror 150. Therefore, it is possible to provide the display apparatus 100B capable of switching the infinite mirror image to the non-display state. Note that the light source 160 may be provided on the inner wall of the casing 110 or the like without providing the projection 111.

### Display apparatus 100C

The display apparatus 100C as illustrated in FIG. 4C has a configuration in which the switchable area 120A of the display apparatus 100 as illustrated in FIG. 1 is enlarged in a plan view. In a cross section as illustrated in FIG. 4C, the switchable area 120A is located over the entire portion of the glass plates 122 and 124 that is not covered with the sealing seal 123.

In order to achieve the switchable area 120A enlarged in this manner, as an example, the electrode 122A, as illustrated in FIGS. 2A and 2B, may be entirely formed by the electrode 1 and similarly, the electrode 124A may be entirely formed by the electrode 2. In this case, there is no portion where the electrodes 1 or the electrodes 2 face each other outside the switchable area 120A as illustrated in FIGS. 2A and 2B.

In the display apparatus 100C, the state in which the infinite mirror image is displayed and the state in which the infinite mirror image is not displayed can be switched one to another by switching the switchable area 120A, which has been enlarged, between the transmissive state and the non-transmissive state. Therefore, it is possible to provide the display apparatus 100C capable of switching the infinite mirror image to the non-display state. Note that the light sources 160 may be provided on the inner wall of the casing 110 or the like without providing the projection 111.

The enlarged switchable area 120A described above may be applied to the display apparatus 100A as illustrated in FIG. 4A and the display apparatus 100B as illustrated in FIG. 4B.

### Display apparatus 100D

A display apparatus 100D as illustrated in FIG. 4D has a configuration in which the plurality of light sources 160 of the display apparatus 100 as illustrated in FIG. 1 are attached to the lower surface of the partial reflection mirror 150. In this configuration, the projection 111 is not required. The plurality of light sources 160 are disposed outside the switchable area 120A along the switchable area 120A in a plan view. The plurality of light sources 160 are disposed in a state of facing obliquely downward toward the central portion of the total reflection mirror 140. That is, the central axis of the light emission of the light source 160 is inclined with respect to a straight line (a straight line parallel to the Z-axis) perpendicular to the lower surface of the partial reflection mirror 150 and the upper surface of the total reflection mirror 140.

In the display apparatus 100D including the plurality of light sources 160 arranged in this manner, a part of the light output from the light sources 160 and reflected by the total reflection mirror 140 is transmitted through the partial reflection mirror 150, and the remaining light is reflected by the total reflection mirror 140 again. By repeating this operation, the reflected virtual images obtained between the total reflection mirror 140 and the partial reflection mirror 150 are overlapped in many layers at equal intervals in the depth direction while becoming gradually smaller, and an infinite mirror image is obtained as in the display apparatus 100 as illustrated in FIG. 1.

### Display apparatus 100E

A display apparatus 100E as illustrated in FIG. 4E has a configuration in which the plurality of light sources 160 of the display apparatus 100 as illustrated in FIG. 1 are attached to the upper surface of the total reflection mirror 140. In this configuration, the projection 111 is not required. The plurality of light sources 160 are disposed outside the switchable area 120A along the switchable area 120A in a plan view. The plurality of light sources 160 are disposed in a state of facing obliquely upward toward the central portion of the partial reflection mirror 150. That is, the central axis of the light emission of the light source 160 is inclined with respect to a straight line (a straight line parallel to the Z-axis) perpendicular to the lower surface of the partial reflection mirror 150 and the upper surface of the total reflection mirror 140.

In the display apparatus 100E including the plurality of light sources 160 arranged in this manner, a part of the light output from the light sources 160 is transmitted through the partial reflection mirror 150, and the remaining light is reflected by the total reflection mirror 140 and is incident on the partial reflection mirror 150 again. By repeating this operation, the reflected virtual images obtained between the total reflection mirror 140 and the partial reflection mirror 150 are overlapped in many layers at equal intervals in the depth direction while becoming gradually smaller, and an infinite mirror image is obtained as in the display apparatus 100 as illustrated in FIG. 1.

### Display apparatus 100F

A display apparatus 100F as illustrated in FIG. 4F has a configuration in which the plurality of light sources 160 of the display apparatus 100 as illustrated in FIG. 1 are attached to the projection 111 to face obliquely upward. The projection 111 of the display apparatus 100F is inclined such that the light sources 160 are directed obliquely upward. The plurality of light sources 160 are arranged in a state of facing obliquely upward toward the central portion of the partial reflection mirror 150. That is, the central axis of the light emission of the light source 160 is inclined with respect to a straight line (a straight line parallel to the Z-axis) perpendicular to the lower surface of the partial reflection mirror 150 and the upper surface of the total reflection mirror 140.

In the display apparatus 100F including the plurality of light sources 160 arranged in this manner, a part of the light output from the light sources 160 is transmitted through the partial reflection mirror 150, and the remaining light is reflected by the total reflection mirror 140 and is incident on the partial reflection mirror 150 again. By repeating this operation, the reflected virtual images obtained between the total reflection mirror 140 and the partial reflection mirror 150 are overlapped in many layers at equal intervals in the depth direction while becoming gradually smaller, and an infinite mirror image is obtained as in the display apparatus 100 as illustrated in FIG. 1. Note that the light source 160 may be provided on the inner wall of the casing 110 or the like without providing the projection 111.

### Display apparatus 100G

A display apparatus 100G as illustrated in FIG. 4G has a configuration in which the plurality of light sources 160 of the display apparatus 100 as illustrated in FIG. 1 are attached to the projection 111 to face obliquely downward. The projection 111 of the display apparatus 100G is inclined such that the light sources 160 are directed obliquely downward. The plurality of light sources 160 are arranged in a state of facing obliquely downward toward the central portion of the total reflection mirror 140. That is, the central axis of the light emission of the light source 160 is inclined with respect to a straight line (a straight line parallel to the Z-axis) perpendicular to the lower surface of the partial reflection mirror 150 and the upper surface of the total reflection mirror 140.

In the display apparatus 100G including the plurality of light sources 160 arranged in this manner, a part of the light output from the light sources 160 and reflected by the total reflection mirror 140 is transmitted through the partial reflection mirror 150, and the remaining light is reflected by the total reflection mirror 140 again. By repeating this operation, the reflected virtual images obtained between the total reflection mirror 140 and the partial reflection mirror 150 are overlapped in many layers at equal intervals in the depth direction while becoming gradually smaller, and an infinite mirror image is obtained as in the display apparatus 100 as illustrated in FIG. 1. Note that the light source 160 may be provided on the inner wall of the casing 110 or the like without providing the projection 111.

### Experimental results of infinite mirror image

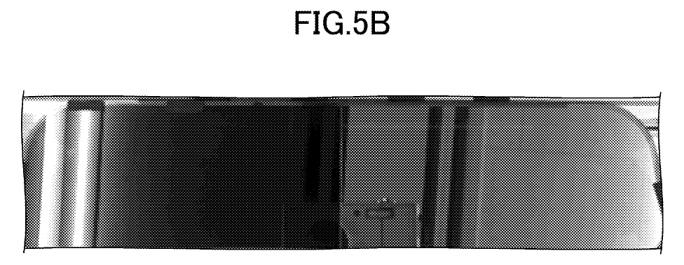

FIGS. 5A and 5B are diagrams illustrating examples of experimental results of the display apparatus according to the embodiment. FIG. 5A illustrates a state in which the switchable area 120A of the liquid crystal display 120 is switched to the transmissive state and the antireflection layer 130 is viewed. FIG. 5B illustrates a state in which the switchable area 120A of the liquid crystal display 120 is switched to the non-transmissive state and the antireflection layer 130 is viewed.

The left half of an experimental display apparatus has the structure of the display apparatus 100 (see FIG. 1), and the right half has the structure of the display apparatus 100B (see FIG. 4B). That is, the left half of the experimental display apparatus includes the partial reflection mirror 150, and the right half includes the reflective polarizing plate 121B.

In FIG. 5A, a plurality of light sources 160 and other internal structures are visible along the left, right, and top edges. Other visible internal structures are the inner surface or the like of the casing 110 between the total reflection mirror 140 and the partial reflection mirror 150 in the left half, and the inner surface or the like of the casing 110 between the total reflection mirror 140 and the reflective polarizing plate 121B in the right half. The black objects present along the left and right edges and the upper edge are black resin tapes for fixing components.

As shown in FIG. 5A, an infinite mirror image was obtained in which reflected virtual images of the plurality of light sources 160 and other internal structures were overlapped in many layers at equal intervals in the depth direction while becoming gradually smaller along the left and right edges and the upper edge.

As shown in FIG. 5B, in a state where the switchable area 120A is switched to the non-transmissive state, nothing is reflected on the left half and the left half appears black, and an image of the front of the antireflection layer 130 is reflected on the right half like a mirror.

As described above, when the switchable area 120A is switched to the transmissive state, an infinite mirror image is displayed as shown in FIG. 5A. When the switchable area 120A is switched to the non-transmissive state, the infinite mirror image can be hidden as shown in FIG. 5B.

As shown in FIG. 5B, when the partial reflection mirror 150 is used, a black display without reflection on the antireflection layer 130 is obtained in the non-transmissive state, and when the reflective polarizing plate 121B is used, a display with reflection on the antireflection layer 130 is obtained in the non-transmissive state.

### Effects

The display apparatus 100 includes the liquid crystal display 120, the partially transmissive plate provided on the back surface side of the liquid crystal display 120, the total reflection mirror 140 provided on the side opposite to the liquid crystal display 120 with respect to the partially transmissive plate and facing the partially transmissive plate with a space between the partially transmissive plate and the total reflection mirror 140, and the light sources 160 (first light source) having central axes of light emission directed to the partially transmissive plate or the total reflection mirror 140 and outputting light to a region (space) between the partially transmissive plate and the total reflection mirror. Therefore, the light output from the light source 160 is repeatedly reflected between the total reflection mirror 140 and the partially transmissive plate, and each time the light enters the partially transmissive plate, a part of the light is transmitted through the partially transmissive plate in the direction from the lower surface to the upper surface, thereby obtaining an infinite mirror image. By switching the voltage applied to the liquid crystal layer 126 of the liquid crystal display 120, it is possible to switch between a transmissive state in which an infinite mirror image can be displayed and a non-transmissive state in which an infinite mirror image is not displayed.

Therefore, it is possible to provide the display apparatuses 100 and 100A to 100G capable of switching the infinite mirror image to the non-display state.

In addition, in the display apparatuses 100 and 100A to 100G, since the light sources 160 are disposed outside the switchable area 120A in a plan view, the size of the region outside the switchable area 120A can be set to any size in accordance with the size of the light sources 160. Since the light sources 160 can be disposed inside the outer edge of the liquid crystal display 120 in a plan view, the display apparatuses 100 and 100A to 100G can be downsized.

The partially transmissive plate may be the partial reflection mirror 150. The amount of light of multiple reflection repeated between the total reflection mirror 140 and the partial reflection mirror 150 can be set by the reflectivity of the partial reflection mirror 150, and the intensity of display of the infinite mirror image can be set.

The liquid crystal display 120 may include the liquid crystal layer 126, the glass plate 124 provided on the first side (+Z-direction side) opposite to the partial reflection mirror 150 with respect to the liquid crystal layer 126, the glass plate 122 provided on the second side (-Z-direction side) opposite to the first side with respect to the liquid crystal layer 126, a pair of electrodes 1 (first electrodes), and a pair of electrodes 2 (second electrodes). The pair of electrodes 1 may be connected to each other to have the same potential, and each of the pair of electrodes 1 may be correspondingly provided on the glass plate 124 and the glass plate 122. The pair of electrodes 2 may be connected to each other to have the same potential, and each of the pair of electrodes 2 may be correspondingly provided on the glass plate 124 and the glass plate 122. The electrode 1 of the glass plate 124 and the electrode 2 of the glass plate 122 may overlap with each other in the central portion of the glass plate 124 and the glass plate 122 in a plan view. The pair of electrodes 1 may overlap with each other and the pair of electrodes 2 may overlap with each other in the portion outside the central portion of the glass plate 124 and the glass plate 122 in a plan view.

When voltage is applied to the liquid crystal layer 126, only the switchable area 120A is in the transmissive state, and an infinite mirror image can be displayed. When no voltage is applied to the liquid crystal layer 126, the entire liquid crystal display 120 including the switchable area 120A is in the non-transmissive state, such that all images can be hidden and the components on the back side (-Z-direction side) of the liquid crystal display 120 can be hidden. When no voltage is applied to the liquid crystal layer 126, the entire liquid crystal display 120 is in a non-transmissive state, and thus all images can be hidden.

The electrode 1 of the glass plate 124 may extend to the ends of the glass plate 124 in the first direction, and the electrode 2 of the glass plate 124 may be provided at the periphery of the electrode 1 of the glass plate 124. The electrode 2 of the glass plate 122 may extend to the ends of the glass plate 122 in the second direction crossing the first direction in a plan view, and the electrode 1 of the glass plate 122 may be provided at the periphery of the electrode 2 of the glass plate 122. The electrode 2 of the electrode 122A and the electrode 1 of the electrode 124A are extended to the corresponding ends of the glass plate 122, such that the electrode 2 of the electrode 122A and the electrode 1 of the electrode 124A are readily connected to an AC-like DC power supply 10 outside the liquid crystal display 120.

The light sources 160 may be provided in an area where the pair of electrodes 1 of the electrode 122A and electrode 124A in a plan view overlap with each other, or in an area where the pair of electrodes 2 of the electrode 122A and electrode 124A in a plan view overlap with each other. The area where the pair of electrodes 1 of the electrode 122A and electrode 124A overlap with each other and the area where the pair of electrodes 2 of the electrode 122A and electrode 124A overlap with each other in a plan view are the areas where the liquid crystal display 120 is always in the non-transmissive state regardless of whether or not voltage is applied to the liquid crystal layer 126. By disposing the light sources 160 in the area that is always in the non-transmissive state, a more attractive infinite mirror image can be displayed, and it is not necessary to provide a component for hiding the light sources 160 in addition to the liquid crystal display 120, such that the configuration can be simplified.

The light sources 160 may be provided on a surface of the partial reflection mirror 150 on a total reflection mirror 140 side or a surface of the total reflection mirror 140 on a partial reflection mirror 150 side. The central axes of light emission of the light sources 160 may be inclined with respect to a straight line perpendicular to the surface of the partial reflection mirror 150 on the total reflection mirror 140 side and the surface of the total reflection mirror 140 on the partial reflection mirror 150 side. The light sources 160 can be attached to the total reflection mirror 140 or the partial reflection mirror 150 without providing a holder for holding the light sources 160. In addition, since the central axis of the light emission of the light source 160 is inclined with respect to the straight line parallel to the Z-axis, the number of times of multiple reflection is increased, and an infinite mirror image with a greater depth can be generated.

The display apparatus may further include the casing 110 (housing) that houses the liquid crystal display 120, the partial reflection mirror 150, the light sources 160, and the total reflection mirror 140. The light sources 160 may be held by a holder provided on the inner surface of the casing 110 such that the central axes of light emission of the light sources 160 are inclined with respect to a straight line perpendicular to the surface of the partial reflection mirror 150 on the total reflection mirror 140 side and the surface of the total reflection mirror 140 on the partial reflection mirror 150 side. Since the light sources 160 can be fixed to the casing 110, the light sources 160 can be provided at a position different from the positions of the total reflection mirror 140 and the partial reflection mirror 150. In addition, since the central axis of the light emission of the light source 160 is inclined with respect to the straight line parallel to the Z-axis, the number of times of multiple reflection is increased, and an infinite mirror image with a greater depth can be generated.

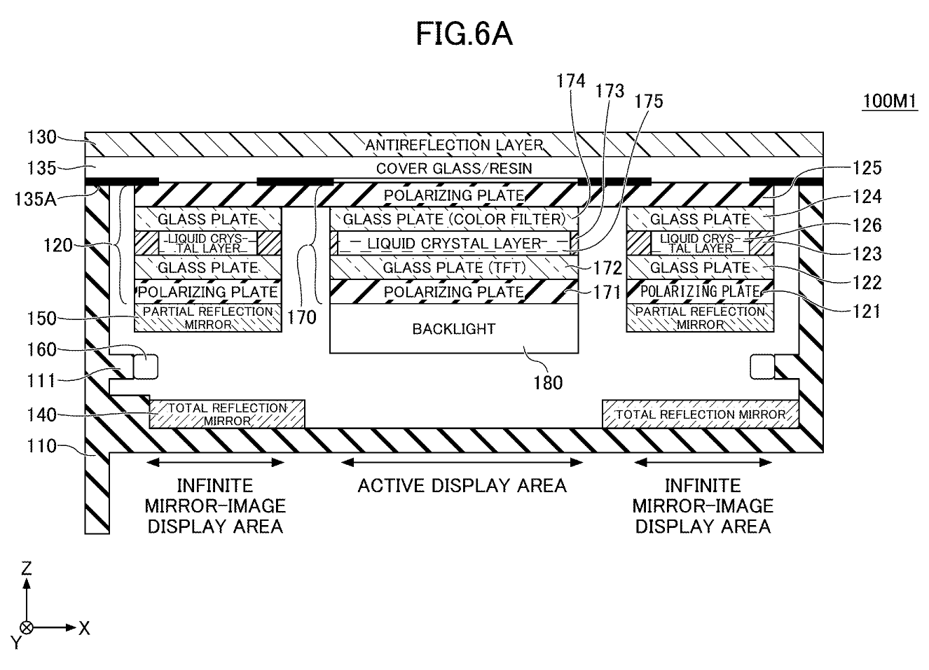

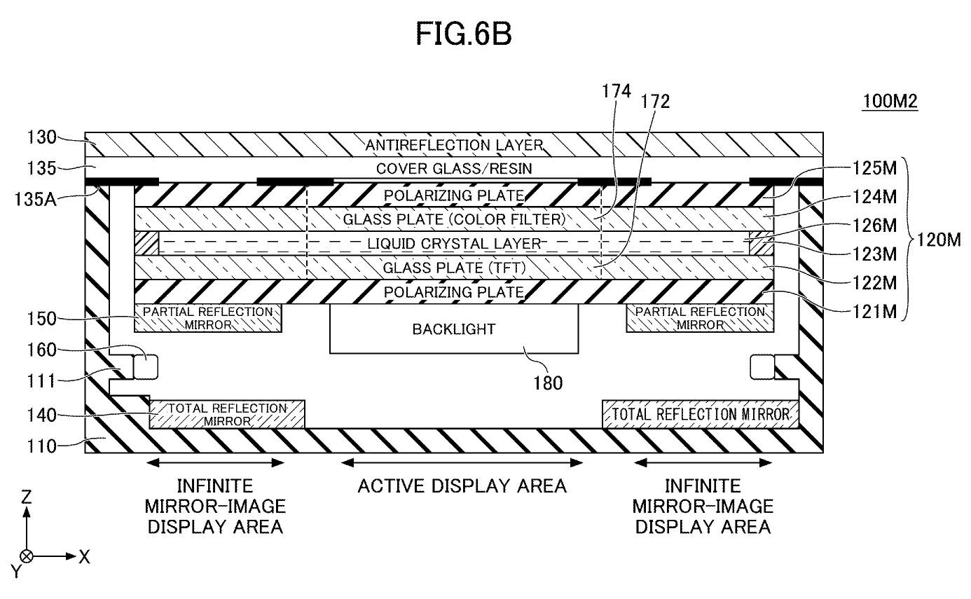

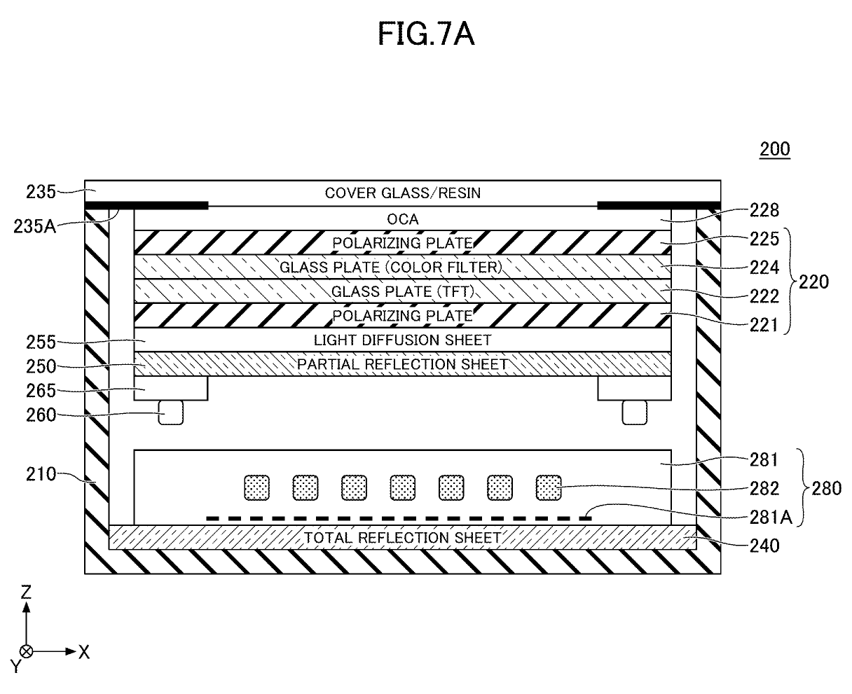

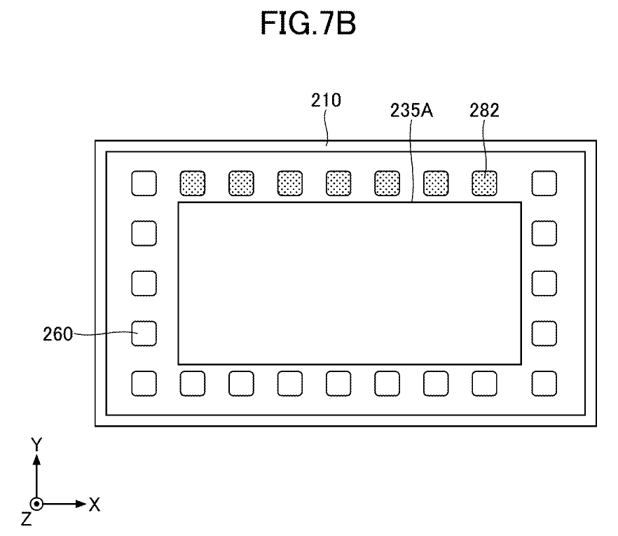

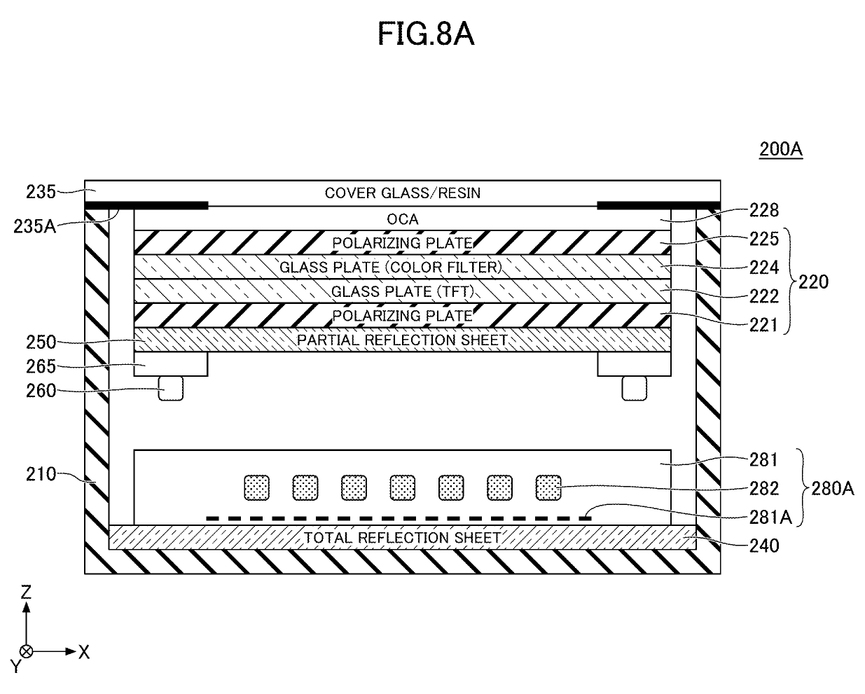

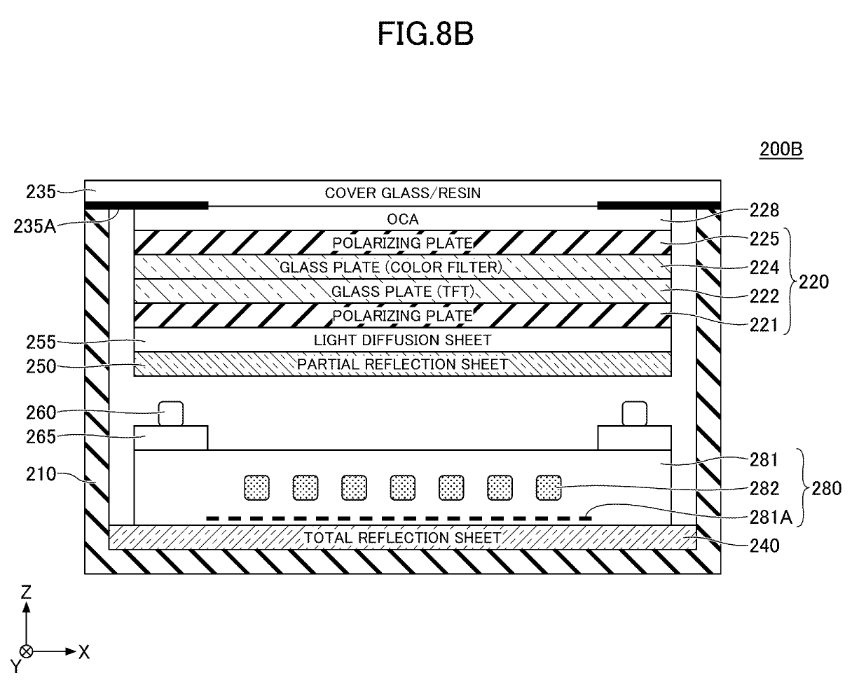

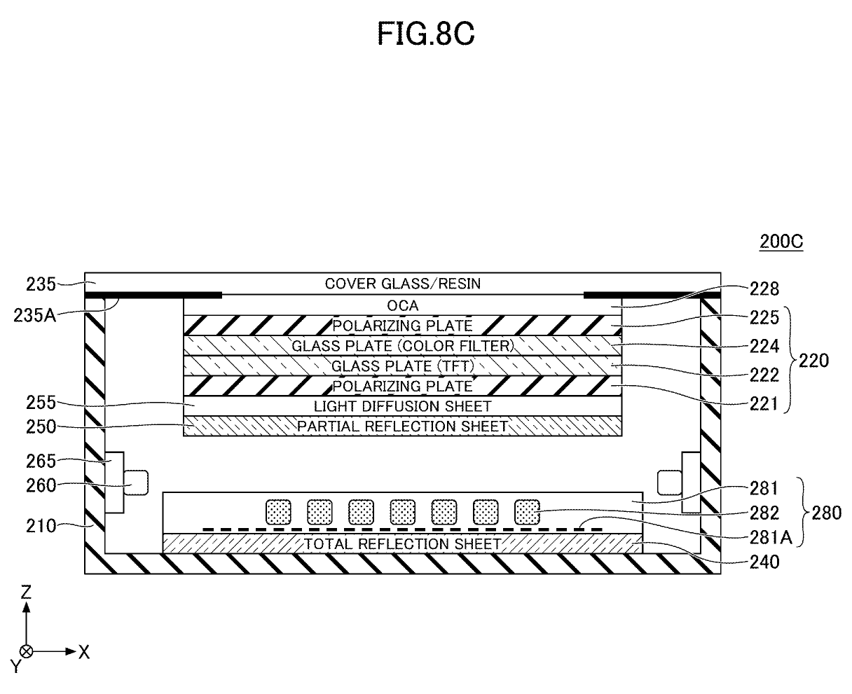

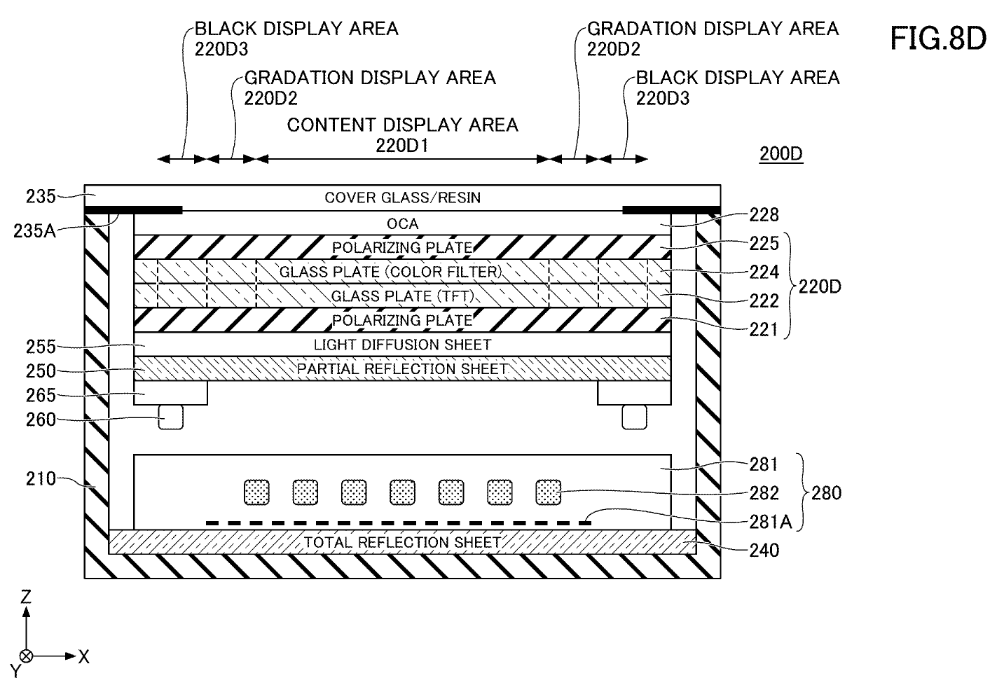

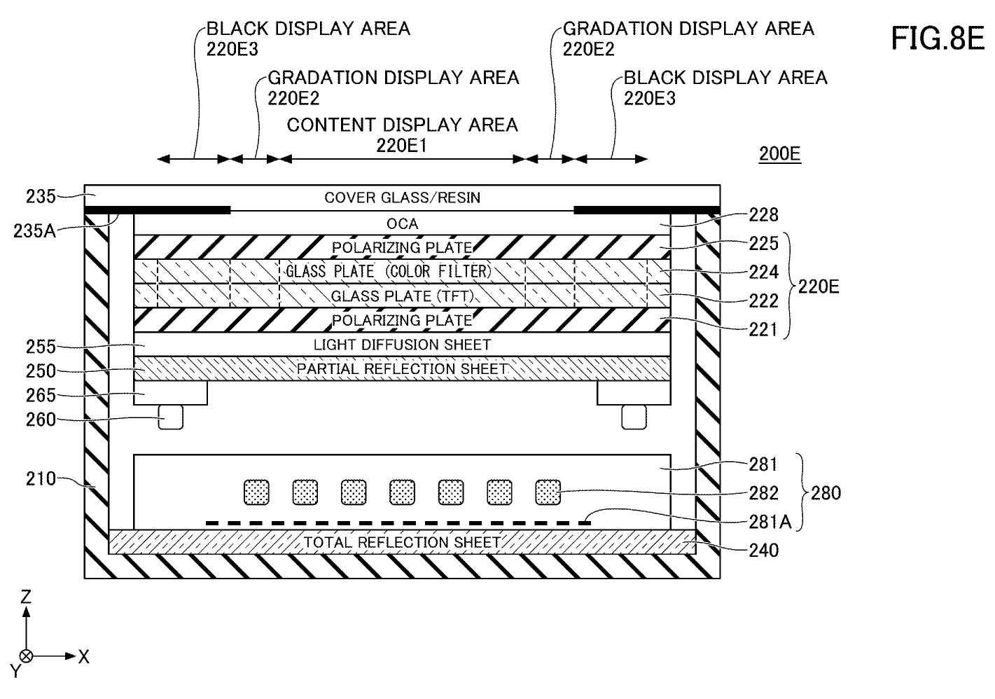

The liquid crystal display apparatus may further include a transparent protective plate disposed on a display surface side of the liquid crystal display 120. The protective plate may be provided with an opaque blindfold portion that overlaps with the outer edge of the liquid crystal display 120, the outer edge of the partial reflection mirror 150, the outer edge of the total reflection mirror 140, and the light sources 160 in a plan view. The outer edges of the liquid crystal display 120, the partial reflection mirror 150, the total reflection mirror 140, and the light source 160 can be hidden by the blindfold portion provided on the protective plate. Note that a configuration including the protective plate will be described with reference to FIG. 6A, FIG. 6B, FIG. 7A, and FIGS. 8A to 8E.

### Modified example

FIG. 6A is a diagram illustrating a configurational example of a display apparatus 100M1 according to a modified example of the embodiment. The display apparatus 100M1 includes a casing 110, liquid crystal displays 120, an antireflection layer 130, a protective plate 135, total reflection mirrors 140, partial reflection mirrors 150, light sources 160, a liquid crystal display 170, and a backlight 180. The liquid crystal display 170 is an example of a first display driven by an active matrix driving method. The two liquid crystal displays 120 are an example of a second display driven by a passive driving method.

The display apparatus 100M1 as illustrated in FIG. 6A includes an infinite mirror-image area for displaying infinite mirror images on the -X-direction side and the +X-direction side, and includes an active display area at the center of the display apparatus 100M1 in the X-direction. In the entire display area of the display apparatus 100M1 in a plan view, the active display area is located in the central portion, and the infinite mirror-image display area is located closer to the end of the active display area as compared with the active display area.

Although the configuration in an XZ cross section will be described hereinafter, the display apparatus 100M1 may have the same configuration in the Y-direction. The display apparatus 100M1 may have the same configuration in the X-direction and Y-direction. That is, the display apparatus 100M1 may include the active display area disposed in the center in a plan view and the infinite mirror-image area disposed to surround the active display area.

The configuration of the infinite mirror-image area of the display apparatus 100M1 is similar to that of the display apparatus 100 as illustrated in FIG. 1, except for the following point. In the display apparatus 100M1, the antireflection layer 130 is provided on the upper surface of the protective plate 135.

The protective plate 135 is a transparent glass plate or a resin plate. The term "transparent" means that light is transmitted. The protective plate 135 includes a decorative layer 135A on the sidewall of the casing 110, the outer edge of the liquid crystal display 120, and the lower surface of a portion corresponding to the boundary between the liquid crystal display 120 and the liquid crystal display 170. The decorative layer 135A is a black decorative layer 135A that conceals the sidewall of the casing 110, the outer edge of the liquid crystal display 120, and the boundary between the liquid crystal display 120 and the liquid crystal display 170.

The casing 110, the polarizing plate 125, and the antireflection layer 130 are shared by the two infinite mirror-image areas and the one active display area.

Each infinite mirror-image area is provided with a liquid crystal display 120, an antireflection layer 130, a total reflection mirror 140, a partial reflection mirror 150, and a light source 160.

In addition, in the active display area, a liquid crystal display 170 and the backlight 180 are arranged. The liquid crystal display 170 includes a polarizing plate 171, a glass plate 172 on which a thin film transistor (TFT) is formed, a sealing seal 173, a glass plate 174 on which a color filter is formed, a polarizing plate 125, and a liquid crystal layer 175.

The polarizing plate 171, the glass plate 172, the sealing seal 173, the glass plate 174, and the polarizing plate 125 are provided in this order from the lower side to the upper side, and the liquid crystal layer 175 is sealed in a space surrounded by the sealing seal 173 having a rectangular annular shape in a plan view and the glass plates 172 and 174.

The backlight 180 is an edge-type backlight and is attached below the polarizing plate 171. The backlight 180 includes a light guide that guides light output from a light source provided at an end on the -X-direction side, the +X-direction side, the -Y-direction side, or the +Y-direction side in the +Z-direction. The backlight 180 illuminates the liquid crystal display 170 from the -Z-direction side.

The liquid crystal display 170 drives the TFTs formed on the glass plate 172 by an active matrix method. In this way, various images such as still images and moving images can be displayed in the active display area.

Therefore, the display apparatus 100M1 can display various images in the active display area and can display an infinite mirror image in the infinite mirror-image display area.

As described above for the display apparatus 100M1, the liquid crystal display may include the first display (liquid crystal display 170) driven by the active matrix driving method and the second display (liquid crystal display 120) driven by the passive driving method, and the partial reflection mirror 150 may be provided on the back surface side of the second display (liquid crystal display 120). The active matrix driving method can provide the display apparatus 100M1 capable of displaying various images such as still images and moving images and switching the infinite mirror image to the non-display state in the second display. Note that the light source 160 may be provided on the inner wall of the casing 110 or the like without providing the projection 111.

Note that, instead of the liquid crystal display 170 and the backlight 180, liquid crystal displays 220, 220D, and 220E of the display apparatuses 200 and 200A to 200E, and backlights 280 and 280A of a second embodiment described in the following may be used.

### Display apparatus 100M2 of modified example of embodiment

FIG. 6B is a cross-sectional diagram illustrating a configurational example of a display apparatus 100M2 according to a modified example of the embodiment.

The display apparatus 100M2 as illustrated in FIG. 6B is different from the display apparatus 100M1 as illustrated in FIG. 6A in that the display apparatus 100M2 shown in FIG. 6B includes a liquid crystal display 120M in which two liquid crystal displays 120 and one liquid crystal display 170 as illustrated in FIG. 6A are integrated. Therefore, the liquid crystal display 120M will be described in the following.

The display apparatus 100M2 as illustrated in FIG. 6B includes infinite mirror-image areas for displaying infinite mirror images on the -X-direction side and the +X-direction side, and includes an active display area at the center in the X-direction. In the entire display area of the display apparatus 100M2 in a plan view, the active display area is located in the central portion, and the infinite mirror-image display area is located closer to the end of the active display area as compared with the active display area.

Although the configuration in the XZ cross section will be described hereinafter, the display apparatus 100M2 may have the same configuration in the Y-direction. The display apparatus 100M2 may have the same configuration in the X-direction and Y-direction. That is, the display apparatus 100M2 may include the active display area disposed in the center in a plan view and the infinite mirror-image area disposed to surround the active display area.

The liquid crystal display 120M includes a polarizing plate 121M, a glass plate 122M, a sealing seal 123M, a glass plate 124M, a polarizing plate 125M, and a liquid crystal layer 126M. The polarizing plate 121M, the glass plate 122M, the sealing seal 123M, the glass plate 124M, the polarizing plate 125M, and the liquid crystal layer 126M are shared by the active display area and the infinite mirror-image area.

The glass plate 122M includes the TFT formed in a portion within the active display area, and a color filter is provided in a portion within the active display area of the glass plate 124M. The liquid crystal layer 126M is driven by the active matrix driving method in the active display area, whereby various images can be displayed.

In addition, the glass plates 122M and 124M are formed with electrodes capable of achieving the switchable area 120A in the portion within the infinite mirror-image display area, and the transmissive state and the non-transmissive state of the liquid crystal layer 126M within the infinite mirror-image display area can be switched. When the liquid crystal layer 126M in the infinite mirror-image display area is switched to the transmissive state, an infinite mirror image can be displayed.

As described above, the liquid crystal display 120M may include a first display area (active display area) driven by the active matrix driving method and a second display area (infinite mirror-image display area) driven by the passive driving method, and the partial reflection mirror 150 may be provided on the back surface side of the second display area. The active matrix driving method can provide the display apparatus 100M2 capable of displaying various images such as still images and moving images and switching the infinite mirror image to the non-display state in the second display. Furthermore, the first display area (active display area) and the second display area (infinite mirror-image display area) can be displayed in one liquid crystal display 120M.

Note that, instead of the portion of the liquid crystal display 120M in the active display area and the backlight 180, the liquid crystal displays 220, 220D, and 220E of the display apparatuses 200 and 200A to 200E and the backlights 280 and 280A of the second embodiment described in the following may be used. Furthermore, the light sources 160 may be provided on the inner wall or the like of the casing 110 without providing the projection 111.

### Second embodiment

FIG. 7A is a cross-sectional diagram illustrating a configurational example of a display apparatus 200 according to the second embodiment. The display apparatus 200 includes a casing 210, a liquid crystal display 220, a protective plate 235, a total reflection sheet 240, a partial reflection sheet 250, a light diffusion sheet 255, light sources 260, a substrate 265, and a backlight 280. The partial reflection sheet 250 is an example of a partially transmissive plate and an example of a partial reflection mirror. The light sources 260 are an example of the first light source.

The casing 210 and the light sources 260 are respectively similar to the casing 110 and the light sources 160 of the display apparatus 100 (see FIG. 1) of the first embodiment.

The protective plate 235 is the same as that of the display apparatus 100M1 (see FIG. 6A) of the modified example of the embodiment. The total reflection sheet 240 and the partial reflection sheet 250, in the form of sheet-like members, are used instead of the total reflection mirror 140 and the partial reflection mirror 150 of the display apparatus 100 (see FIG. 1) of the first embodiment. The display apparatus 200 does not include the antireflection layer 130 (see FIG. 1), but may include the antireflection layer 130. The upper surface of the protective plate 235 is a display surface of the display apparatus 200.

Hereinafter, the components of the display apparatus 200 of the second embodiment will be described focusing on the differences from the display apparatus 100 of the first embodiment. The display apparatus 200 of the second embodiment is similar to the display apparatus 100 of the first embodiment in that the display apparatus 200 is capable of displaying an infinite mirror image.

### Casing 210

The casing 210 is a housing of the display apparatus 200. The casing 210 is, for example, box-shaped and rectangular in a plan view. The casing 210 includes an opening in an upper portion of the casing 210, and includes an internal space that communicates with the opening and extends downward. Such an internal space is an example of a region, and more specifically, an example of a three-dimensional region. The total reflection sheet 240 is disposed at the bottom of the internal space of the casing 210, and the protective plate 235 is provided at the opening of the upper portion. The internal space of the casing 210 may be sealed with, for example, a transparent resin. The portion in which the transparent resin is sealed in the internal space in this manner is a three-dimensional region inside the casing 210.

### Liquid crystal display 220

The liquid crystal display 220 is bonded to the lower surface of the protective plate 235 by an optical clear adhesive (OCA) 228, for example. Instead of the OCA 228, an optical clear resin (OCR) may be used.

The liquid crystal display 220 includes a polarizing plate 221, a glass plate 222, a glass plate 224, and a polarizing plate 225. In FIG. 7A, the sealing seal 123 and the liquid crystal layer 126 as illustrated in FIG. 1 are omitted. The glass plate 224 is an example of the first glass plate, and the glass plate 222 is an example of the second glass plate.

The liquid crystal display 220 is, for example, a liquid crystal display driven by the active matrix driving method. For this reason, the TFT is formed on the upper surface of the glass plate 222, and the color filter is provided on the lower surface of the glass plate 224. The liquid crystal display 220 driven by the active matrix driving method can display various images such as still images and moving images. The configuration and operation of the liquid crystal display 220 are the same as those of the liquid crystal display 170 as illustrated in FIG. 6A, and thus detailed description thereof will be omitted.

The protective plate 235 is a transparent glass plate or a resin plate. The term "transparent" means that light is transmitted. The protective plate 235 includes a decorative layer 235A in a portion where the outer edges of the OCA 228, liquid crystal display 220, light diffusion sheet 255, and partial reflection sheet 250, as well as the light sources 260 and substrates 265 are located in a plan view. The decorative layer 235A is provided on the lower surface of the protective plate 235, and is a black decorative layer that conceals the outer edges of the OCA 228, liquid crystal display 220, light diffusion sheet 255, and partial reflection sheet 250, as well as the light sources 260 and substrate 265. The decorative layer 235A has a rectangular annular shape in a plan view, and an inner edge of the decorative layer 235A is located inside an edge of the substrate 265 on the center side, which will be described in the following.

### Total reflection sheet 240

The total reflection sheet 240 is provided at the bottom of the internal space of the casing 210, and the upper surface thereof is a reflection surface that totally reflects light. The total reflection sheet 240 is a sheet of the total reflection mirror 140 of the first embodiment, and functions as a total reflection mirror. The total reflection sheet 240 can be produced by, for example, vapor-depositing aluminum on the upper surface of a sheet-like member. The total reflection sheet 240 is not limited to such a configuration, and may have any configuration as long as the total reflection sheet has a reflection surface that totally reflects light as an upper surface. The total reflection mirror 140 of the first embodiment may be used instead of the total reflection sheet 240.

### Partial reflection sheet 250

The partial reflection sheet 250 is attached to the lower surface of the liquid crystal display 220 via the light diffusion sheet 255. The partial reflection sheet 250 is a sheet of the partial reflection mirror 150 of the first embodiment, and functions as a partial reflection mirror. The light transmittance of the partial reflection sheet 250 may be set to an appropriate value within a range from about 20% to about 80%, and more preferably, may be set to an appropriate value within a range from about 30% to about 70%, as an example. Here, as an example, the light transmittance of the partial reflection sheet 250 is assumed to be 50%.

The partial reflection sheet 250 transmits light coming from below from the lower surface toward the upper surface, and reflects the remaining light downward on the lower surface.

Here, the partial reflection mirror 150 of the first embodiment (see FIG. 1) may be used instead of the partial reflection sheet 250, or the hard coating 150A of the display apparatus 100A of the modified example of the embodiment (see FIG. 4A) may be used instead of the partial reflection sheet 250.

### Light diffusion sheet 255

The light diffusion sheet 255 is a sheet that diffuses incident light, and an LED diffusion sheet can be used, for example. The light diffusion sheet 255 has adhesiveness, for example. Therefore, the partial reflection sheet 250 can be attached to the lower surface of the polarizing plate 221 of the liquid crystal display 220 by the light diffusion sheet 255. By providing the light diffusion sheet 255, light can be sufficiently scattered on the lower side of the liquid crystal display 220, and thus, an infinite mirror image can be displayed.

### Light source 260

The light sources 260 are mounted on the lower surface of the substrate 265 attached to the lower surface of the partial reflection sheet 250, for example. The light source 260 is an LED as an example, but may be a light emitter other than an LED. The light sources 260 output light to a space (region) between the partial reflection sheet 250 and the total reflection sheet 240.

Hereinafter, the arrangement of the light sources 260 will be described with reference to FIG. 7B in addition to FIG. 7A. FIG. 7B is a diagram illustrating an example of a positional relationship between the light sources 260 and 282 in a plan view. The side walls of the casing 210 and the inner edge of the decorative layer 235A are also shown in FIG. 7B.

The plurality of light sources 260 are provided at equal intervals in a plan view along three of the four side walls of the casing 210. The three side walls of the casing 210 are, for example, a side wall extending in the Y-direction on the -X-direction side, a side wall extending in the X-direction on the -Y-direction side, and a side wall extending in the Y-direction on the +X-direction side.

The central axes of light emission of the light sources 260 are inclined with respect to a straight line (a straight line parallel to the Z-axis) perpendicular to the lower surface of the partial reflection sheet 250 and the upper surface of the total reflection sheet 240. More specifically, the central axes of light emission of the light sources 260 are configured to be directed obliquely downward toward the central portion of a light guide 281 of the backlight 280, as an example. This is because, by inclining the central axes of light emission of the light sources 260 with respect to the straight line perpendicular to the lower surface of the partial reflection sheet 250 and the upper surface of the total reflection sheet 240 (a straight line parallel to the Z-axis), light is obliquely incident on the total reflection sheet 240 and the partial reflection sheet 250, the number of times of multiple reflection increases, and an infinite mirror image with a greater depth is obtained.

### Substrate 265

The substrate 265 is provided along the three side walls of the casing 210 described above on the lower surface of the partial reflection sheet 250. The substrate 265 is bonded to the lower surface of the partial reflection sheet 250 by a transparent adhesive such as the OCA, for example. In the XZ cross-sectional diagram, the substrate 265 has a width in the X-direction greater than that of the light source 260, and both ends in the X-direction are located outside the light sources 260. The same applies to a YZ cross-sectional diagram of a section in which the light sources 260 are provided along the X-direction on the -Y-direction side. That is, the width of the substrate 265 in the Y-direction is greater than that of the light source 260, and both ends of the substrate in the Y-direction are located outside the light sources 260.

As the substrate 265, a wiring substrate such as a printed wiring board (PWB) or a flexible printed circuit (FPC) can be used, for example. Note that the terminals of the light sources 260 are connected to an external device of the display apparatus 200 via the wiring of the substrate 265 or the like and further via wiring or the like (not illustrated), and the lighting control of the light sources 260 is performed by the external device, for example.

### Backlight 280

The backlight 280 is an edge-type backlight and is attached to the upper surface of the total reflection sheet 240. The backlight 280 includes the light guide 281 and a plurality of light sources 282. The light source 282 is an example of a second light source. The backlight 280 is located on the -Z-direction side of the light sources 260.

The light guide 281 is provided substantially on the entire total reflection sheet 240. A light guide pattern 281A that reflects light upward is provided in a central portion of the lower surface of the light guide 281 excluding both ends in the X-direction and the Y-direction. The light guide pattern 281A is a film or the like formed by applying a material or the like that reflects light, or minute unevenness provided on the lower surface of the light guide 281.

The light source 282 is an LED as an example, but may be a light emitter other than an LED. As an example, as illustrated in FIG. 7B, the plurality of light sources 282 are provided toward the -Y-direction side in the vicinity of the bottom portion of the sidewall extending in the X-direction on the +Y-direction side among the four sidewalls of the casing 210. The plurality of light sources 282 are disposed along the side wall extending in the X-direction on the +Y-direction side of the casing 210, specifically, disposed in a section excluding the -X direction-side end and the +X direction-side end. This is to prevent the light sources 282 from overlapping with the light sources 260 disposed at the end portion on the -Y-direction side among the plurality of light sources 260 disposed on the X-direction side and the +X-direction side in a plan view.

The reason why the plurality of light sources 282 are provided along the side wall extending in the X-direction on the +Y-direction side of the casing 210 and are disposed in the section excluding the end portion on the -X-direction side and the end portion on the +X-direction side is to make it easy to see the infinite mirror image by disposing the plurality of light sources 282 at positions not overlapping with the plurality of light sources 260 in a plan view. In a case where the display of the infinite mirror image is not affected, the light source 282 of the backlight 280 may be provided at a position overlapping with the light source 260 in a plan view.

In the display apparatus 200, when the light sources 260 and the light sources 282 of the backlight 280 are turned on and the liquid crystal display 220 displays an image, the image of the liquid crystal display 220 is displayed in a rectangular display area surrounded by the decorative layer 235A of the protective plate 235.

Furthermore, since the central axis of the light emission of the light source 260 is inclined with respect to the straight line perpendicular to the partial reflection sheet 250 and the total reflection sheet 240 (the straight line parallel to the Z-axis), the light is obliquely incident on the total reflection sheet 240 and the partial reflection sheet 250. Therefore, the number of times of multiple reflections between the total reflection sheet 240 and the partial reflection sheet 250 increases, and infinite mirror images are displayed at the end portions on the -X-direction side, the -Y-direction side, and the +X-direction side in the rectangular display area surrounded by the decorative layer 235A of the protective plate 235. The end portions on the -X-direction side, the -Y-direction side, and the +X-direction side of the rectangular display area surrounded by the decorative layer 235A are positions corresponding to the three side walls of the casing 210 on which the plurality of light sources 260 are provided.

As described above, the display apparatus 200 of the second embodiment can display an infinite mirror image. To be more specific, the display apparatus 200 of the second embodiment can display an image of the liquid crystal display 220 in the central portion of a rectangular display area surrounded by the decorative layer 235A of the protective plate 235, and can display an infinite mirror image in the periphery of the image of the liquid crystal display 220.

### Display apparatuses 200A to 200E of modified examples of second embodiment

FIGS. 8A to 8E are cross-sectional diagrams illustrating a configurational example of the display apparatuses 200A to 200E according to the modified examples of the second embodiment. FIGS. 8A to 8E are diagrams illustrating cross-sectional configurations in the XZ plane corresponding to the display apparatus 200 as illustrated in FIG. 7A. The same components as those of the display apparatus 200 as illustrated in FIG. 7A are denoted by the same symbols, and the description thereof is omitted.

### Display apparatus 200A

A display apparatus 200A as illustrated in FIG. 8A has a configuration in which the light diffusion sheet 255 of the display apparatus 200 as illustrated in FIG. 7A is omitted and the backlight 280A is included instead of the backlight 280 as illustrated in FIG. 7A.

A light transmitting material of the light guide 281 in the backlight 280A has a light scattering function by containing nanoparticles (nano-scattering material) as an example. Therefore, the display apparatus 200A can sufficiently scatter light on the lower side of the liquid crystal display 220 without including the light diffusion sheet 255, and can display an infinite mirror image similarly to the display apparatus 200 as illustrated in FIG. 7A.

### Display apparatus 200B

A display apparatus 200B as illustrated in FIG. 8B has a configuration in which the light sources 260 and the substrate 265 of the display apparatus 200 as illustrated in FIG. 7A are moved to the upper surface of the light guide 281 of the backlight 280, and the light sources 260 are disposed upward.

The central axes of light emission of the light sources 260 of the display apparatus 200B are directed obliquely upward to face the central portion of the partial reflection sheet 250. That is, the central axes of light emission of the light sources 260 are inclined with respect to a straight line (a straight line parallel to the Z-axis) perpendicular to the lower surface of the partial reflection sheet 250 and the upper surface of the total reflection sheet 240. This is because light is obliquely incident on the total reflection sheet 240 and the partial reflection sheet 250, the number of times of multiple reflection increases, and an infinite mirror image with a greater depth is obtained.

The display apparatus 200B can display an infinite mirror image similarly to the display apparatus 200 as illustrated in FIG. 7A by the configuration in which the light sources 260 and the substrate 265 are disposed on the upper surface of the light guide 281.

### Display apparatus 200B

A display apparatus 200B as illustrated in FIG. 8B has a configuration in which the light sources 260 and the substrate 265 of the display apparatus 200 as illustrated in FIG. 7A are moved to the upper surface of the light guide 281 of the backlight 280, and the light sources 260 are disposed upward. For example, the substrate 265 may be bonded to the upper surface of the light guide 281 with a transparent adhesive such as the OCA.

The central axes of light emission of the light sources 260 in the display apparatus 200B are directed obliquely upward to face the central portion of the partial reflection sheet 250. That is, the central axes of light emission of the light sources 260 are inclined with respect to a straight line (a straight line parallel to the Z-axis) perpendicular to the lower surface of the partial reflection sheet 250 and the upper surface of the total reflection sheet 240. This is because light is obliquely incident on the total reflection sheet 240 and the partial reflection sheet 250, the number of times of multiple reflection increases, and an infinite mirror image with a greater depth is obtained.

The display apparatus 200B can display an infinite mirror image similarly to the display apparatus 200 as illustrated in FIG. 7A by the configuration in which the light sources 260 and the substrate 265 are disposed on the upper surface of the light guide 281.

### Display apparatus 200C

A display apparatus 200C as illustrated in FIG. 8C has a configuration in which the light sources 260 and the substrate 265 of the display apparatus 200 as illustrated in FIG. 7A are moved to the inner surfaces of the sidewall of the casing 210. For example, the substrate 265 may be bonded to the sidewall of the casing 210 with a transparent adhesive such as the OCA.

The central axes of light emission of the light sources 260 of the display apparatus 200C may be inclined with respect to a straight line (a straight line parallel to the Z-axis) perpendicular to the lower surface of the partial reflection sheet 250 and the upper surface of the total reflection sheet 240, as in the display apparatus 100 (see FIG. 1) of the first embodiment. This is because light is obliquely incident on the total reflection sheet 240 and the partial reflection sheet 250, the number of times of multiple reflection increases, and an infinite mirror image with a greater depth is obtained.

The central axis of the light emission of each light source 260 has an angle of about 70 degrees in absolute value with respect to a straight line perpendicular to the partial reflection sheet 250 and the total reflection sheet 240 (a straight line parallel to the Z-axis), for example. In other words, the central axis of the light emission of the light source 260 has an angle of about 20 degrees upward or downward with respect to the horizontal direction, as an example. The light output from each light source 260 is propagated radially in a wide range to directly reach the total reflection sheet 240 on the lower side and directly reach the partial reflection sheet 250 on the upper side.

The display apparatus 200C can display an infinite mirror image similarly to the display apparatus 200 as illustrated in FIG. 7A by the configuration in which the light sources 260 and the substrates 265 are disposed on the inner surfaces of the side wall of the casing 210. In addition, since the light sources 260 and the substrate 265 are disposed on the inner surfaces of the sidewall of the casing 210 in the display apparatus 200C, the length between the total reflection sheet 240 and the partial reflection sheet 250 in the Z-direction can be shortened. Therefore, the display apparatus 200C can be made thinner than the display apparatus 200 (see FIG. 7A), the display apparatus 200A (see FIG. 8A), and the display apparatus 200B (see FIG. 8B).

### Display apparatus 200D

A display apparatus 200D as illustrated in FIG. 8D has a configuration in which the liquid crystal display 220 of the display apparatus 200 as illustrated in FIG. 7A is replaced with the liquid crystal display 220D.

The liquid crystal display 220D includes a content display area 220D1, a gradation display area 220D2, and a black display area 220D3 from the center side to an outer edge side of the liquid crystal display 220D in a plan view. In a plan view, the content display area 220D1 has a rectangular shape, the gradation display area 220D2 has a rectangular annular shape surrounding the content display area 220D1, and the black display area 220D3 has a rectangular annular shape surrounding the gradation display area 220D2 and the content display area 220D1.

For example, the liquid crystal display 220D of the display apparatus 200D has a relatively low brightness, and thus the components inside the casing 210 are less visible than the protective plate 235, and the light sources 260 and the substrate 265 are less visible from the display surface of the display apparatus 200D. Therefore, the light sources 260 and the substrate 265 may be located inside the inner edge of the decorative layer 235A, in other words, the inner edge of the decorative layer 235A may be located further outward from the inner edge of the decorative layer 235A. The inner edge of the decorative layer 235A may be positioned further outward, which means that the distance between the inner edge and the outer edge of the decorative layer 235A may be reduced.

Note that, also in the case where the contrast of the liquid crystal display 220D is relatively high, the components inside the casing 210 are less likely to be seen than the protective plate 235, and the light sources 260 and the substrate 265 are less likely to be seen from the display surface of the display apparatus 200D, as in the case where the brightness is relatively low. Therefore, even when the contrast of the liquid crystal display 220D is relatively high, the inner edge of the decorative layer 235A may be located further outward, and the distance between the inner edge and the outer edge of the decorative layer 235A may be reduced.

The content display area 220D1 is an area where images such as various still images and moving images can be displayed by driving the TFT provided on the upper surface of the glass plate 222 by the active matrix driving method.

The gradation display area 220D2 is an area in which the color gradation is increased stepwise from the inside close to the content display area 220D1 to the outside close to the black display area 220D3. Such control of the color gradation is referred to as stepwise gradation control. Since the gradation display area 220D2 is an area where an infinite mirror image is displayed, the infinite mirror image is displayed more clearly by performing the stepwise gradation control.

The black display area 220D3 is provided to overlap with the inner edge of the decorative layer 235A in a plan view. In other words, the inner edge of the decorative layer 235A is located inside the black display area 220D3 having a rectangular annular shape in a plan view.

The black display area 220D3 is an area where the liquid crystal display 220 is displayed in black. The black display area 220D3 displays black like an inward extension of the black decorative layer 235A when the display apparatus 200D is viewed from the display surface side. The black display area 220D3 hides the substrate 265 and the like located inside the inner edge of the decorative layer 235A in a plan view. In this manner, the black display area 220D3 displays black as in the inward extension portion of the decorative layer 235A, thereby hiding the substrate 265 and the like while achieving a sense of unity with the decorative layer 235A.

The display apparatus 200D displays various images such as still images and moving images in the content display area 220D1, and increases the color gradation level of the surrounding gradation display area 220D2, thereby displaying an infinite mirror image clearly. That is, the display apparatus 200D can clearly display both various images such as still images, moving images, and infinite mirror images.

The display apparatus 200D is suitable for the case where the brightness of the liquid crystal display 220D is relatively low or the contrast is relatively high.

### Display apparatus 200E

The display apparatus 200E as illustrated in FIG. 8E has a configuration in which the liquid crystal display 220 of the display apparatus 200 as illustrated in FIG. 7A is replaced with the liquid crystal display 220E.

The liquid crystal display 220E includes a content display area 220E1, a gradation display area 220E2, and a black display area 220E3 from the center side to the outer edge side of the liquid crystal display 220E in a plan view. The content display area 220E1, the gradation display area 220E2, and the black display area 220E3 are different in size in a plan view from the content display area 220D1, the gradation display area 220D2, and the black display area 220D3 as illustrated in FIG. 8D, but are the same in shape and arrangement.

In the display apparatus 200E as illustrated in FIG. 8E, the inner edge of the decorative layer 235A is located further inward than in the display apparatus 200D as illustrated in FIG. 8D. That is, the distance between the inner edge and the outer edge of the rectangular annular decorative layer 235A of the display apparatus 200E as illustrated in FIG. 8E is greater than the distance between the inner edge and the outer edge of the decorative layer 235A of the display apparatus 200D as illustrated in FIG. 8D.

The liquid crystal display 220E of the display apparatus 200E has, for example, a relatively high brightness, and thus the components inside the casing 210 are more readily visible than the protective plate 235, and the light sources 260 and the substrate 265 are readily visible from the display surface of the display apparatus 200E. Therefore, when the light sources 260 and the substrate 265 are located inside the inner edge of the decorative layer 235A, they may be seen, and it is preferable to locate the inner edge of the decorative layer 235A further inside.

Even when the contrast of the liquid crystal display 220E is relatively low, the components inside the casing 210 are more readily visible than the protective plate 235, and the light sources 260 and the substrate 265 are more readily visible from the display surface of the display apparatus 200E, as in the case where the brightness is relatively high. Therefore, even when the contrast of the liquid crystal display 220E is relatively low, it is preferable to position the inner edge of the decorative layer 235A further inside. For this reason, the distance between the inner edge and the outer edge of the rectangular annular decorative layer 235A of the display apparatus 200E is greater than the distance between the inner edge and the outer edge of the decorative layer 235A of the display apparatus 200D as illustrated in FIG. 8D.

The roles of the content display area 220E1, the gradation display area 220E2, and the black display area 220E3 are the same as the roles of the content display area 220D1, the gradation display area 220D2, and the black display area 220D3 as illustrated in FIG. 8D, respectively. However, due to the difference in the width of the decorative layer 235A, the content display area 220E1, the gradation display area 220E2, and the black display area 220E3 are configured as follows.

The content display area 220E1 can display various images such as still images and moving images by the active matrix driving method, similarly to the content display area 220D1, but the content display area 220E1 is slightly smaller than the content display area 220D1.

The gradation display area 220E2 is an area in which an infinite mirror image is clearly displayed by performing the stepwise gradation control similarly to the gradation display area 220D2, but the outer edge of the gradation display area 220E2 substantially coincides with the inner edge of the decorative layer 235A. In the stepwise gradation control, it is preferable to control the color gradation to change smoothly such that the color gradation changes as continuously as possible.

The black display area 220E3 displays black color similarly to the black display area 220D3, but is provided at a position overlapping with the decorative layer 235A.

Since the liquid crystal display 220E has high brightness or low contrast, the components such as the light sources 260 and the substrate 265 inside the casing 210 are readily visible, and thus, in order to reliably hide these components, the positions of the gradation display area 220E2 and the black display area 220E3 and the width of the decorative layer 235A are adjusted as described above as an example.

In the above description, the decorative layer 235A is widened to hide the internal components, and the black display area 220E3 and the decorative layer 235A are adjusted to overlap with each other. However, the positions of the gradation display area 220E2 and the black display area 220E3 and the widths of the decorative layer 235A may be adjusted in relation to the color gradation level of the gradation display area 220E2, the gradation level of the black color of the black display area 220E3, the appearance of the internal components, and the like.

The display apparatus 200E displays various images such as still images and moving images in the content display area 220E1, and increases the color gradation level of the surrounding gradation display area 220E2, thereby displaying an infinite mirror image clearly. That is, the display apparatus 200E can clearly display both various images such as still images, moving images, and infinite mirror images.

The display apparatus 200E is suitable for the case where the brightness of the liquid crystal display 220E is relatively high or the contrast is relatively low.

### Actual measurement example of gradation control

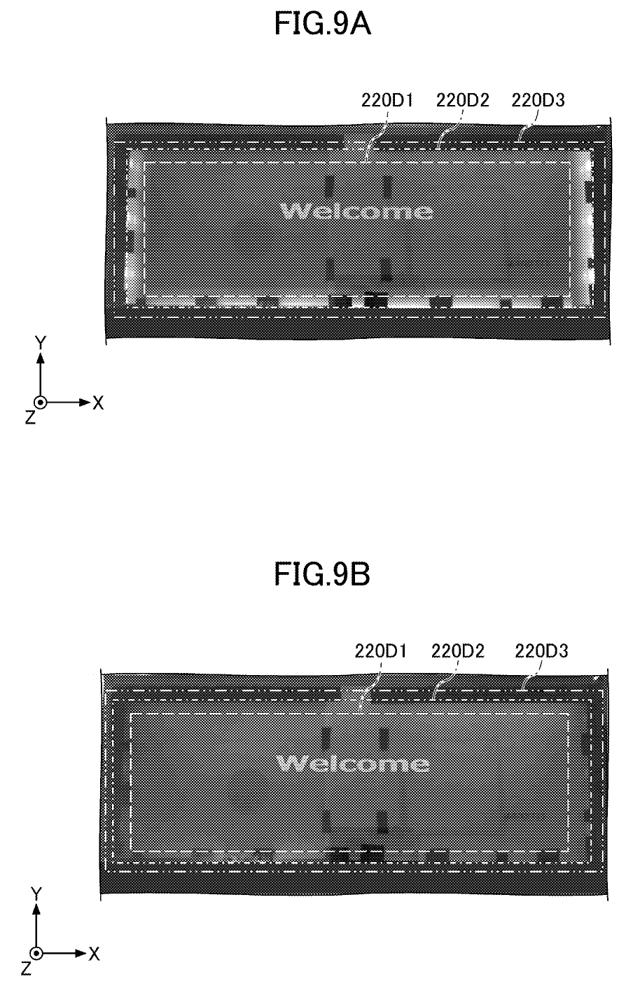

FIGS. 9A and 9B are diagrams illustrating actual measurement examples of the gradation control in the display apparatus 200D. FIGS. 9A and 9B illustrate the display state in the display area (inside the inner edge of the decorative layer 235A) of the protective plate 235 in the display apparatus 200D. Note that the gradation level of the liquid crystal display 220D can be controlled by 256 gradations for each of RGB, for example, and the brightest (lightest) grayscale is L255 and the darkest (darkest) grayscale is L0.

In FIGS. 9A and 9B, the content display area 220D1 is indicated by a broken line, the gradation display area 220D2 is indicated by a one-dot chain line, and the black display area 220D3 is indicated by a two-dot chain line.

In FIGS. 9A and 9B, an image in which characters of "Welcome" are arranged at the center of a black background is displayed on the liquid crystal display 220, and the color gradations of the content display area 220D1, the gradation display area 220D2, and the black display area 220D3 are set as follows.

FIG. 9A illustrates a state in which the light sources 260 are turned on (lit), the backlight 280 is turned on (lit), and the color gradation level of the background image of the content display area 220D1 is set to L7 (the eighth level from L0). In FIG. 9A, the gradation level of the gradation display area 220D2 is set to L7 at the inner end and L255 at the outer end by the stepwise gradation control. The gradation level of the black display area 220D3 was set to L0 (black).

FIG. 9B illustrates a state in which the light sources 260 are turned off (unlit), the backlight 280 is turned on (lit), and the gradation level of the image of the content display area 220D1 is set to L7 (the eighth level from L0). In FIG. 9B, the gradation is set to L7 without performing the stepwise gradation control in the gradation display area 220D2. The gradation level of the black display area 220D3 was set to L0 (black).

As can be seen from the comparison between FIG. 9A and FIG. 9B, it was confirmed that the infinite mirror image can be displayed more clearly by performing the stepwise gradation control in the content display area 220D1 (see FIG. 9A) than in the case where the stepwise gradation control is not performed (see FIG. 9B). Furthermore, it was confirmed that the infinite mirror image can be displayed clearly in the same manner even when the gradation level of the image in the content display area 220D1 is set to L7, the innermost side of the gradation display area 220D2 is set to L7, and the outermost side of the gradation display area 220D2 is set to L0.

### EFFECTS

The display apparatus 200 includes a liquid crystal display 220, a partially transmissive plate (partial reflection sheet 250) provided on the back side of the liquid crystal display 220, and a total reflection mirror (total reflection sheet 240) provided on the opposite side of the liquid crystal display 220 with respect to the partially transmissive plate and facing the partially transmissive plate with a space between the partially transmissive plate and the total reflection mirror. The display apparatus 200 includes an edge-type backlight (backlight 280) that includes a first light source (light sources 260) having central axes of light emission directed to the partially transmissive plate or the total reflection mirror and outputting light to a region (space) between the partially transmissive plate and the total reflection mirror, a second light source (light sources 282), and a light guide 281 guiding light output from the second light source, and is provided closer to the total reflection mirror than the light sources 260. Therefore, multiple reflection of the reflected virtual image is obtained between the partially transmissive plate and the total reflection mirror, and an infinite mirror image can be displayed.

Therefore, the display apparatus 200 capable of displaying an infinite mirror image can be provided.

The partially transmissive plate may be a partial reflection mirror (partial reflection sheet 250). The light amount of the multiple reflection repeated between the total reflection mirror and the partial reflection mirror (partial reflection sheet 250) can be set by the reflectivity of the partial reflection mirror (partial reflection sheet 250), and the intensity of the display of the infinite mirror image can be set.

The liquid crystal display 220 may include a gradation display area 220D2 that displays a gradation image, and light output from the light sources 260 may be incident on the gradation display area 220D2. The light from the light sources 260 is incident on the gradation display area 220D2, and thus an infinite mirror image can be displayed on the gradation display area 220D2.

The light transmissive material of the light guide 281 may contain a nano-scattering material, or the back surface of the light guide 281 may include minute irregularities. By using the backlight 280A including the light guide 281 containing the nano-scattering material or the backlight 280 including the light guide pattern 281A, the light of the backlight 280 can be scattered, and a clearer infinite mirror image can be displayed.

The liquid crystal display 220 may be driven by the active matrix driving method. The display apparatus 200 can display various images such as still images and moving images and can display infinite mirror images around the images.

A display apparatus capable of switching an infinite mirror image to a non-display state can be provided.

Although the display apparatus according to the exemplary embodiment of the present disclosure has been described above, the present disclosure is not limited to the specifically disclosed embodiment, and various modifications and changes can be made without departing from the scope of the claims.

What is claimed is:

1. A display apparatus, comprising:
a liquid crystal display;
a partially transmissive plate provided on a back surface side of the liquid crystal display;
a total reflection mirror provided on a side opposite to the liquid crystal display with respect to the partially transmissive plate and facing the partially transmissive plate with a space from the partially transmissive plate; and
a light source having a central axis of light emission directed to the partially transmissive plate or the total reflection mirror and outputting light to a region between the partially transmissive plate and the total reflection mirror.

2. The display apparatus according to claim 1, wherein
the partially transmissive plate is a partial reflection mirror.

3. The display apparatus according to claim 2, wherein
the liquid crystal display includes
a liquid crystal layer;
a first glass plate provided on a first side of the liquid crystal layer, the first side being opposite to the partial reflection mirror with respect to the liquid crystal layer;
a second glass plate provided on a second side opposite to the first side with respect to the liquid crystal layer;
a pair of first electrodes; and
a pair of second electrodes, wherein
the pair of first electrodes are connected to each other to have a same potential, and each of the pair of first electrodes is correspondingly provided on the first glass plate and the second glass plate,
the pair of second electrodes are connected to each other to have a same potential, and each of the pair of second electrodes is correspondingly provided on the first glass plate and the second glass plate,
a first electrode, the first electrode being from the pair of first electrodes, of the first glass plate and a second electrode, the second electrode being from the pair of second electrodes, of the second glass plate overlap with each other in a central portion of the first glass plate and the second glass plate in a plan view, and
the pair of first electrodes overlap with each other and the pair of second electrodes overlap with each other in a portion outside the central portion of the first glass plate and the second glass plate in a plan view.

4. The display apparatus according to claim 3, wherein
the first electrode of the first glass plate extends to ends of the first glass plate in a first direction,
the second electrode of the first glass plate is provided at a periphery of the first electrode of the first glass plate,
the second electrode of the second glass plate extends to ends of the second glass plate in a second direction crossing the first direction in a plan view, and
the first electrode of the second glass plate is provided at a periphery of the second electrode of the second glass plate.

5. The display apparatus according to claim 3, wherein
the light source is provided in an area where the pair of first electrodes overlap with each other in a plan view, or in an area where the pair of second electrodes overlap with each other in a plan view.

6. The display apparatus according to claim 2, wherein
the light source is provided on a surface of the partial reflection mirror on a total reflection mirror side or a surface of the total reflection mirror on a partial reflection mirror side, and
a central axis of light emission of the light source is inclined with respect to a straight line perpendicular to the surface of the partial reflection mirror on the total reflection mirror side and the surface of the total reflection mirror on the partial reflection mirror side.

7. The display apparatus according to claim 2, the display apparatus further comprising:
a casing that houses the liquid crystal display, the partial reflection mirror, the light source, and the total reflection mirror, wherein
the light source is held by a holder provided on an inner surface of the casing such that the central axis of light emission of the light source is inclined with respect to a straight line perpendicular to a surface of the partial reflection mirror on a total reflection mirror side and a surface of the total reflection mirror on a partial reflection mirror side.

8. The display apparatus according to claim 6, the display apparatus further comprising:
a protective plate that is transparent and disposed on a display surface side of the liquid crystal display, wherein
the protective plate is provided with an opaque blindfold portion that overlaps with an outer edge of the liquid crystal display, an outer edge of the partial reflection mirror, an outer edge of the total reflection mirror, and the light source in a plan view.

9. The display apparatus according to claim 2, wherein
the liquid crystal display includes
a first display driven by an active matrix driving method; and
a second display driven by a passive driving method, and
the partial reflection mirror is provided on a back surface side of the second display.

10. The display apparatus according to claim 2, wherein
the liquid crystal display includes
a first display area driven by an active matrix driving method; and
a second display area driven by a passive driving method, and
the partial reflection mirror is provided on a back surface side of the second display area.
